(19) United States
(12) Patent Application Publication
(10) Pub. No.: US 2026/0023598 A1
(43) Pub. Date: Jan. 22, 2026

(54) COMPUTING SYSTEM WITH AI PROBLEM SOLVING COMPETENCIES

(71) Applicant: HT Research Inc., North Tustin, CA (US)

(72) Inventor: Ivan Chung-Shung Hwang, North Tustin, CA (US)

(73) Assignee: HT Research Inc., North Tustin, CA (US)

(21) Appl. No.: 19/269,339

(22) Filed: Jul. 15, 2025

Related U.S. Application Data
(60) Provisional application No. 63/672,166, filed on Jul. 16, 2024.

(51) Int. Cl. G06F 9/48

(52) U.S. Cl. CPC G06F 9/4881

(57) ABSTRACT

The present invention describes how a workgroup expert system can be established to mimic a real world task-expert and possess the equal four expert-Human-Intelligent (expert-HI) Problem-Solving (PS) competencies, including: 1) real-time concurrent workgroup-AI PS-processing, 2) real-time semantic workgroup-AI PS-transactions, 3) real-time task-domain workgroup-AI PS-collaborations and 4) real-time fine-grained adaptive workgroup-AI PS-services, based on multi-node workgroup architectures with derived workgroup-software methods and developed workgroup-system disciplines. Therefore, according to the Turing Test, the workgroup expert-task system should be deemed “Strong-AI-PS competent” for solving any task that is handled by one task expert with the help of functional processors, while all the current nodes-service-infrastructures with four node-AI-PS competencies can only mimic a group of real world functional processors with pre-developed logic-modelled processor-Human-Intelligent (processor-HI) PS-competencies for solving a pre-defined/specific multi-function-modelled task-oriented problem and should be deemed “Weak-AI-PS competent”.

### CROSS-REFERENCE TO RELATED PATENT APPLICATIONS

The present disclosure claims priority of U.S. Provisional Patent Application No.: 63/672,166 filed on Jul. 16, 2024, which is incorporated herein by reference in its entirety.

The following United States patents and patent applications, including the present application, are related by subject matter. Each of such patents/applications is incorporated by reference herein in its entirety.

U.S. patent application Ser. No. 08/539,066, entitled “DIRECT-ACCESS TEAM/WORKGROUP SERVER SHARED BY TEAM/WORKGROUP COMPUTERS WITHOUT USING A NETWORK OPERATING SYSTEM”, by Ivan Chung-Shung Hwang, filed on Oct. 4, 1995, and granted on Sep. 1, 1998, as U.S. Pat. No. 5,802,391.

U.S. patent application Ser. No. 09/744,194, entitled “SYSTEM AND METHOD FOR IMPLEMENTING WORKGROUP SERVER ARRAY”, by Ivan Chung-Shung Hwang, filed on May 17, 2000, and granted on Mar. 30, 2004, as U.S. Pat. No. 6,715,100.

U.S. patent application Ser. No. 16/270,097, entitled “WORKGROUP HIERARCHICAL CORE STRUCTURES FOR BUILDING REAL-TIME WORKGROUP SYSTEMS”, by Ivan Chung-Shung Hwang, filed on Feb. 7, 2019, and granted on Sep. 28, 2021, as U.S. U.S. Pat. No. 11,132,236.

U.S. patent application Ser. No. 17/484,230, entitled “WORKGROUP HIERARCHICAL CORE STRUCTURES FOR BUILDING REAL-TIME WORKGROUP SYSTEMS”, by Ivan Chung-Shung Hwang, filed on Sep. 24, 2021, and granted on Mar. 21, 2023, as U.S. Pat. No. 11,609,795.

U.S. patent application Ser. No. 17/372,771, entitled “3-LEVEL REAL-TIME CONCURRENT PRODUCTION OPERATION WORKGROUP SYSTEMS FOR FINE-GRAINED PROACTIVE CLOSED-LOOP PROBLEM SOLVING OPERATIONS”, by Ivan Chung-Shung Hwang, filed on Jul. 12, 2021, and granted on Oct. 24, 2023, as U.S. Pat. No. 11,797,299.

### TECHNICAL FIELD

The present invention is related to the field of “Artificial-Intelligence-based Problem-Solving (AI-PS) computing systems”. More specifically, this invention is focused on a series of workgroup computing systems that are already equipped with real-time concurrent workgroup-application PS-processing mechanisms (e.g., the dual-effect of PS from a combination of hardware and software components) and the real-time compilation and de-compilation PS-transaction mechanism between syntax node-application manual-models and semantic workgroup-operation/management-menu-domain, can be further implemented with real-time self-solution improving and self-knowledge-learning workgroup solution and knowledge domains coupled PS-collaboration-mechanisms and real-time workgroup-system-to-system interactive feed-back-control fine-grained adaptive PS-service mechanisms.

In so doing, a workgroup PS-expert system can then be equipped with basic four (4) workgroup-AI PS-competencies, including: 1) real-time concurrent workgroup-AI PS-processes, 2) real-time semantic workgroup-AI PS-transactions, 3) real-time automated workgroup-AI PS-collaborations and 4) real-time peer-to-peer interactive fine-grained adaptive workgroup-AI PS-services. Most importantly, it can fully mimic a real-world PS-expert that possess 4 expert-Human-Intelligent (HI) PS (expert-HI) PS-competencies for real-time solving all the solution-models integrated menu-domain-based service-oriented problems that a PS-expert faces. Therefore, by the definition of Turing Test, the present workgroup expert systems with four (4) workgroup AI-PS competencies that are equal to four (4) expert-HI PS-competencies, can then be deemed Strong-AI-PS capable.

While all the current node-processors and nodes-service-infrastructures that are established to equip with 1) real-time sequential-application node-AI PS-processes, 2) real-time syntax-application model node-AI PS-transactions, 3) lead-time disrupted Solution and knowledge-application models cascaded node-AI PS-collaborations and 4) real-time client-server coarse-grained captive modelled node-AI PS-services, can only mimic a group of real world PS-processors with pre-developed logic-modelled processor-Human-Intelligent (processor-HI) PS-competencies for solving one singular pre-defined/specific solution-model-based service-oriented problem, thereby they are deemed Weak-AI-PS capable by contrast.

### SUMMARY

The present invention is focused on four workgroup architectures, including: 1) workgroup-node processing uni-workgroup-node architecture-1 via enhanced node-processing von Neumann architecture with additional workgroup-processing devices, 2) workgroup-node networking uni-workgroup-node architecture-2 via enhanced node-networking architecture with new workgroup-node network-controllers, 3) workgroup 3-level TeamProcessors WL1-aggregation multi-workgroup-node architecture-3 with Workgroup Linkage-1 (WL1) Controllers, 4) workgroup 3-level TeamProcessors hierarchical WL2 integration multi-workgroup-node architecture-4 with WL2-TeamServers, as illustrated in U.S. Pat. No. 5,802,391 (TeamServer), U.S. Pat. No. 6,715,100 (TeamProcessors/WSA), and U.S. Pat. No. 11,132,236 (workgroup hardware-structure).

Based on these four workgroup architectures, the present invention takes four architectural step-up schemes in generating 1) 3-level workgroup basic building blocks (wBBBs), 2) 3-level wBBBs bottom-up integrated workgroup pylons (wPylons), 3) multiple wPylons coupled wSubsystems and 4) top-level/mid-level top-down wBBBs and base-level wSubsystem integrated workgroup expert systems, as shown in FIG. 2.

In addition, these four workgroup architected hardware substructures and system-structures can be installed with derived workgroup OSs and workgroup software programs, enabling 1) wBBBs with the first concurrent workgroup AI PS-processing competency, 2) wPylons with the second additional semantic workgroup AI PS-transaction competency, 3) wSubsystems with the third additional real-time automated workgroup-AI PS-collaboration competency and 4) workgroup expert systems with the fourth additional real-time peer-to-peer Fine-Grained-Proactive (FGP) workgroup AI PS-service competency.

Based on these four workgroup architectures, together with subsequently derived workgroup software methods and developed workgroup system disciplines, the first task-expert workgroup service system is established to possess four workgroup-AI-PS competencies, which are equal to four expert-HI PS-competencies that a real-world PS-expert possesses. Therefore, the task-expert workgroup service systems should be deemed strong AI-PS capable.

The task-expert workgroup service systems can grow in multiple stages, due to its multi-node dimensional parameters. From point to multi-point-1D, 2D, 3D, multi-3D, the real-time dimensional growth with scalable workgroup-computing capabilities can accommodate the real-world ever-changing production service problem domains with real-time dynamic problem-solving requirements. In addition, with two additional workgroup fail-over multi-workgroup-node architecture-5 and workgroup fail-safe multi-workgroup-node architecture-6, the fail-safe multi-3D feedback control task-expert workgroup service systems can be established. It can be thus defined that all the multi-stage task-expert workgroup-production service systems are generated in the first workgroup evolutionary generation, dubbed wG1.s task-expert workgroup production service systems.

Moreover, wG1.s task-expert workgroup production service systems can further evolve into the next 6 workgroup evolutionary generations based on the above-mentioned six (6) hierarchy-integration-centric workgroup architectures, thereby, generating all 7-generation strong-AI-PS workgroup expert-service systems to accommodate the real world service-oriented problem domains, from the smallest production service domains with wG1.s workgroup production task-expert service systems, to multi-production assembly service domains with wG2.s workgroup assembly Job-expert service systems, to multi-assembly fabrication service domains with wG3.s workgroup fabrication Case-expert service systems, to multi-fabrication transaction service domains with wG4.s workgroup transaction Contract-expert service systems, to multi-transaction business-service domains with wG5.s workgroup business expert-service systems, to multi-business consumer service domains with wG6.s workgroup consumer expert-service systems and to the largest multi-consumer individual service-domains with wG7.s workgroup individual expert service systems.

Furthermore, based on four additional workgroup tier-agent-aggregation multi-workgroup-node architecture-7, multi-workgroup tier zone-agent integration multi-workgroup-node architecture-8, multi-workgroup-zone platform-agent-aggregation multi-workgroup-node architecture-9 and multi-workgroup platform Internet-agent integration multi-workgroup-node architecture-10, the workgroup business expert-service systems in generation-5 can further multi-stage evolve into workgroup (small, mid-size, large) Enterprise zone/platform/Internet agent-service systems, dubbed SmartEnterprises, workgroup consumer expert-service systems in generation-6 can further multi-stage evolve into workgroup (home, car, robot) Apparatus zone/platform/Internet agent-service systems, dubbed SmartHomes/SmartCars/SmartRobots and workgroup individual expert-service systems in generation-7 can further multi-stage evolve into workgroup (stationary, portable, wearable) PDA zone/platform/Internet agent-service systems, dubbed SmartPDAs. All of these SmartEnterprises, SmartHomes, SmartCars, SmartRobots and SmartPDAs will become the backbone of the Strong Artificial-General-Intelligent (AGI) Agent-service-oriented Internet, which satisfies individual Maslow-5 needs with secure and fine-grained proactive services.

In conclusion, the true fact is that the current two uni-node architecture-based node-Computing-Paradigm (nCP) is weak-(processor)-AI capable with only three uni-node breakthrough advancements, including: 1) multi-thread node-computing, 2) parallel-accelerating (single-application internal concurrent) node-computing, 3) client-server neural-data-network node-computing. While this 10 workgroup-architecture-based workgroup-Computing-Paradigm (wCP) is strong-(expert)-AI and strong-(agent)-AGI capable with 10 workgroup-computing breakthrough advancements, where the first three (3) are modified uni-workgroup node architecture-based workgroup computing breakthrough advancements including: 1) multi-thread workgroup-node computing, 2) parallel-accelerating workgroup-node computing, 3) client-server neural-data-network workgroup-node computing and the additional seven (7) are multi-workgroup-node architecture-based workgroup-computing breakthrough advancements, including: 4) multi-application concurrent-processing workgroup computing, 5) menu-domain semantic-programming workgroup computing, 6) solution and knowledge domains collaborative automations workgroup computing, 7) peer-to-peer two-way-interactive Fine-Grained-Proactive (FGP) services workgroup computing, 8) fail-over-services workgroup computing, 9) fail-safe services workgroup computing and 10) evolutionary 7-generations/stages expert & agent-service systems workgroup computing.

It is the objective of the present invention is to illustrate how these ten workgroup hardware architectures & Software methods dual-effects-combined Mechanisms-enabled workgroup-computing advancements become possible and why they are the foundation for enabling strong-(expert)-AI and strong-(agent)-AGI problem solving capabilities. In addition, these 10 workgroup architecture generated 7-generation workgroup service systems can accommodate all the real-world service-oriented problem domains, providing real-time peer-to-peer adaptive Fine-Grained Proactive (FGP) Internet services to anyone, anytime/anywhere without security and privacy issues. However, all the current weak-(processor)-AI efforts on parallel-accelerating node-computing is just too primitive in non-evolutionary AI visions and based on two uni-node architectures, the current nCP only generates weak-AI nodes-service-infrastructures with three uni-node based computing advancements, which cannot accommodate all the real world service-oriented problem domains, providing only client-server modelled captive Coarse-Grained Reactive (CGR) Internet services with unsolvable hackable-security and captive-privacy issues that may lead to dire consequences.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit other equally effective embodiments.

FIG. 1 is a block diagram depicting a Nodes-service infrastructure, comprising solution-LAN, knowledge-LAN and a database, forming a disrupted PS-collaboration cycle that enables Weak-AI lead-time solution improving and lead-time knowledge learning programming, equipping with three computing advancements, according to at least one embodiment of the present invention.

FIG. 2 is a block diagram depicting an exemplary embodiment of the current disclosure of the first real-time feedback-control-based Point-closed-loop multi-application-integrated Strong-AI Point task-expert workgroup service system, equipping a computing environment with seven computing advancements, according to at least one embodiment of the present invention.

FIG. 3 is a block diagram of a real-time concurrent feedback-control-based 1D closed-loop multi-application-integrated Strong-AI 1D task-expert workgroup production service system, equipping with seven computing advancements, according to at least one embodiment of the present invention.

FIG. 4 is a block diagram of a real-time concurrent feedback-control-based 2D closed-loop multi-application-integrated Strong-AI 2D task-expert workgroup production service system, equipping with seven computing advancements, according to at least one embodiment of the present invention.

FIG. 5 is a block diagram of a real-time concurrent feedback-control-based 3D closed-loop multi-application-integrated Strong AI 3D task-expert workgroup production service system, equipping with seven computing advancements, according to at least one embodiment of the present invention.

FIG. 6 is a block diagram of a real-time concurrent feedback-control-based fractal closed-loop multi-application-integrated Strong-AI Fractal task-expert workgroup production service system, equipping with seven computing advancements, according to at least one embodiment of the present invention.

FIG. 7 is a block diagram of a wG1.stage real-time “fail-safe” Strong-AI fractal task-expert workgroup production service system, equipping with 9 computing advancements, according to at least one embodiment of the present invention.

FIG. 8 is a block diagram of a fail-safe Strong-AI Job-expert workgroup assembly services system using 6 workgroup architectures and equipping 10 computing advancements with Strong-AI Job-expert of multiple Strong-AI task-experts based evolutionary generation-growth in the second workgroup generation (wG2), according to at least one embodiment of the present invention.

FIG. 9 is a block diagram of a fail-safe Strong-AI Case-expert workgroup fabrication services system using 6 workgroup architectures and equipping 10 computing advancements with more advanced Case-expert of multiple Job-experts based evolutionary generation-growth in the third workgroup generation (wG3), according to at least one embodiment of the present invention.

### DETAILED DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

The present invention describes how a workgroup expert system can be established to mimic a real world task-expert and possess the equal four expert-Human-Intelligent (expert-HI) Problem-Solving (PS) competencies, including: 1) real-time concurrent workgroup-AI PS-processing, 2) real-time semantic workgroup-AI PS-transactions, 3) real-time task-domain workgroup-AI PS-collaborations and 4) real-time fine-grained adaptive workgroup-AI PS-services, based on multi-node workgroup architectures with derived workgroup-software methods and developed workgroup-system disciplines. While the current node Computing Paradigm (nCP) comprises only two uni-node architectures (including: von Neumann and node-networking) with derived node-software methods and developed node-system disciplines, generates node-processors and nodes-service-infrastructures that can only achieve 1) real-time sequential node-AI PS-processes, 2) real-time syntax-model node-AI PS-transactions, 3) lead-time disrupted task-models-based node-AI PS-collaborations and 4) real-time client-server captive coarse-grained reactive node-AI PS-services. Therefore, according to the Turing Test, the workgroup expert-task system should be deemed “Strong-AI-PS competent” for solving any task that is handled by one task expert with the help of functional processors, while all the current nodes-service-infrastructures with four node-AI-PS competencies can only mimic a group of real world functional processors with pre-developed logic-modelled processor-Human-Intelligent (processor-HI) PS-competencies for solving a pre-defined/specific multi-function-modelled task-oriented problem and should be deemed “Weak-AI-PS competent”.

The present invention further illustrates the strong-AI workgroup Computing Paradigm (wCP) that comprises ten workgroup architectures, which establish 7-generation workgroup service systems to encapsulate the real-world service domains, from the smallest multi-function task-service domains to the largest individual-service domains on the Internet, providing real-time solution-improving and knowledge learning enabled Strong-AI-PS capabilities. Most importantly, these ten workgroup architectures not only enhance the current three uni-workgroup-node “step-up” Weak-(processor)-AI computing advancements, including: 1) multi-thread workgroup-node computing, 2) parallel-accelerating (single-application internal-concurrent) workgroup-node computing and 3) client-server data-networking workgroup-node computing, but also enable seven multi-workgroup-node “step-up” Strong-(expert) AI and Strong-(agent)-AGI workgroup computing advancements, including: 1) multi-application concurrent-processing workgroup computing, 2) semantic-domain programming workgroup computing, 3) collaborative-domains automations workgroup computing, 4) peer-to-peer interactive-services workgroup computing, 5) fail-over services workgroup computing, 6) fail-safe services workgroup computing, 7) evolutionary generations/stages expert/agent service-systems workgroup computing, advancing the digital computing in the correct multi-node step-up direction and under the right multi-node evolutionary vision.

### 1.0 Based on the Turing Test Concept to Define Strong/Weak AI PS Computing Systems.

The Turing Test measures the intelligence of a test subject to determine whether a machine can demonstrate intelligence that is equal to human intelligence in problem solving. Therefore, a computer system with installed computing programs can mimic human intelligence for problem solving and carry out the problem-solving task, then the said/subject computing system should be considered as AI-PS capable, including: an AI-PS computing system.

In a real world environment, a problem-solving expert, such as a conveyer controller that manages menu-itemized (e.g., request/reply) solutions (e.g., solution domain) that are integrated by a series of manual-modelled IO-applications performed by the supporting workstation-processors, or a dentist that utilizes a service menu to deal with a patient and then concurrently operates and manages multiple dental equipment with or without other helpers based on an equipment processing manual, possesses the following four expert Human-Intelligent (expert-HI) [semantic-menu-(multi-application operations & managements)-domain] problem-solving (PS) competencies.

A real-world human PS-expert possesses four (4) Human-Intelligent (HI) PS competencies, i.e., 1) real-time concurrent PS-processing, 2) real-time semantic PS-transactions, 3) real-time automated PS-collaborations and 4) real-time peer-to-peer interactive Fine-Grained-Proactive (FGP) PS-services. Therefore, based on the Turing test, if an AI-PS computing system can mimic a real-world Human PS-expert with the equal four (4) expert-HI PS-competencies, then the said system is deemed Strong-AI-PS capable, performing any task that a PS-expert faces. If not, then the said-system is deemed Weak-AI-PS capable, performing only one specific task for a certain purpose.

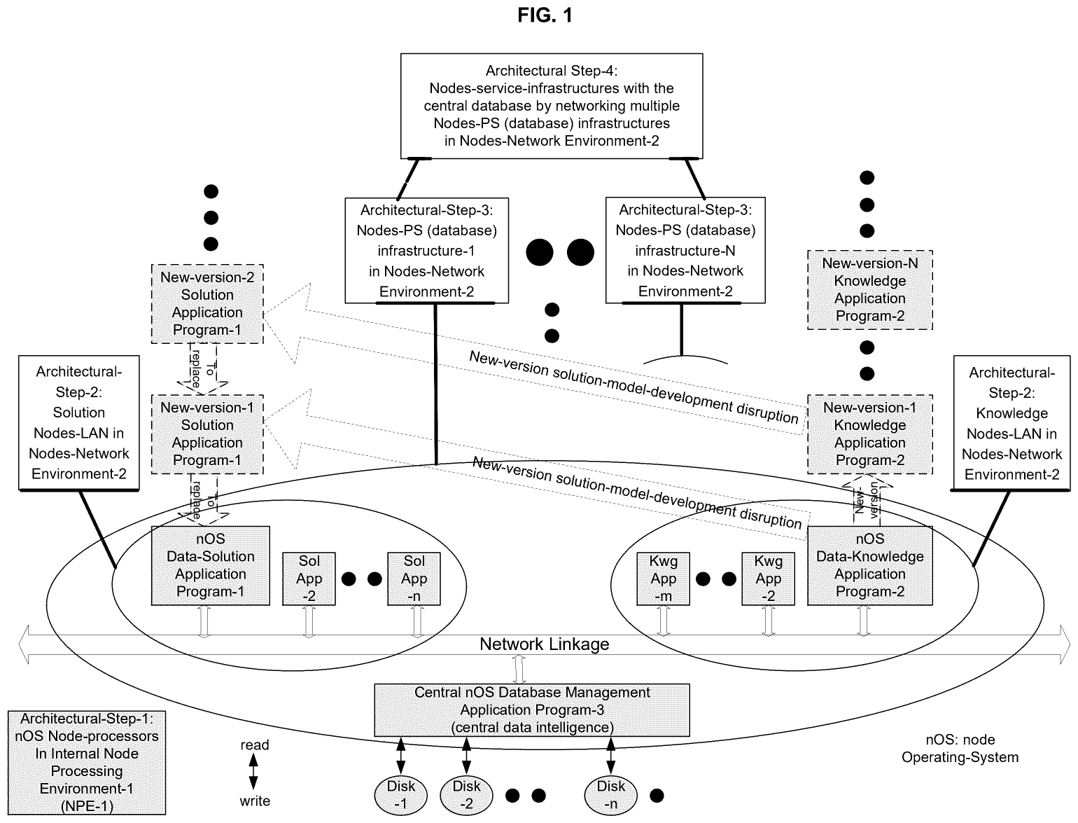

The current node-computing paradigm, comprise two (2) uni-node architectures, i.e., node-processing von Neumann architecture and node-networking architecture, takes four architectural step-up schemes in progressively generating 1) node-processors, 2) multiple node-processors networked nodes-LAN-infrastructures, 3) multiple nodes-LAN-infrastructures networked nodes-PS-infrastructures and 4) multiple nodes-PS-infrastructures networked nodes-service-infrastructures, as shown in the FIG. 1.

In addition, these four uni-node-architected hardware structures/infrastructures can further be installed with node-OSs and node application software programs, enabling 1) node-processors with the first real-time sequential node-AI PS-processing competency, 2) nodes-LAN-infrastructures with the additional second real-time syntax node-AI PS-transaction competency, 3) nodes-PS-infrastructures with the additional third lead-time disrupted node-AI PS-collaboration competency and 4) node-service infrastructures with the fourth additional real-time client-server captive node-AI-PS-service competency.

It can be concluded that the current node-computing paradigm, based on only two uni-node architectures with subsequently derived node software theories/methods and developed node-system disciplines, generates nodes-service-infrastructures with four node-AI-PS competencies, which are not equal to the four expert-HI PS-competencies that a real-world PS-expert possesses. In fact, two uni-node architecture-enabled nodes-service-infrastructures can only mimic a group of real-world PS-processors with processor-HI-PS capabilities, which can only carry out a pre-set fixated syntax-manual model-based Coarse-Grained-Reactive (CGR) PS-services. They cannot carry out what a real-world PS-expert can do to provide a plurality of real-time adaptive semantic-menu domain-based Fine-Grained Proactive (FGP) PS-services. Therefore, the current node-Computing Paradigm (nCP) is deemed Weak-AI-PS capable, because it can only generate node-processors and nodes-infrastructures that are only Weak-(processor)-AI-PS capable.
1. The first expert-HI PS-competency of real-time multi-machine (syntax-manual-application-models) concurrent PS-processes is to real-time handle concurrent solution and knowledge workgroup (homo/hetero)-application tools and machines (at the same time) based on application-processing-manuals with or without processing helpers;
2. The second expert-HI PS-competency of real-time multi-machine syntax-manual-application-models closed-loop-integrated semantic (Solution and Knowledge) menu operation and management PS-transactions is to real-time conduct semantic menu-domain transactions with requestors inside the menu-solution operation domain and to real-time refer to semantic knowledge-file management menu-domain that contains the descriptions of how each semantic-menu item is currently operated by integrating a series of syntax-manual application-models with performance rankings;
3. The third expert-HI PS-competency of real-time coupled Solution (Operation & Management)-menu/knowledge (Management & Operation)-menu-merged automated PS-collaborations is to real-time constantly update the solution menu items with real-time knowledge learning from “previous solution performance experiences”, based on the real-time automated expertise of collaborating real-time solution-domain improving with real-time knowledge-domain learning;
4. The fourth expert-HI PS-competency of real-time peer-to-peer (feedback-interactive) Task (Solution & Knowledge)-menu-(domain)-based fine-grained-proactive PS-services for servicing requestors is to feedback-control over “every requestor's problem-solving-requirements” and provide the real-time fine-grained proactive PS-services to that particular requestor.

According to the definition of the Turing Test, if a computing system can mimic a real world problem-solving (PS) expert and possess the equal four expert-HI (menu-domain)-PS-competencies, then the said computing system is deemed “Strong-AI (menu-domain)-PS” competent, solving all the dynamic problems in the menu service domain. If not, the said computing system is only “Weak-AI (manual-model)-PS” competent, solving only one fixated problems in a manual application model.

Therefore, a Strong-AI (semantic menu-domain)-PS computing system that can mimic a real world Problem-Solving (PS) expert with or without the help of the directly-controlled processors, should perform any menu-itemized task that a PS-expert faces with real-time concurrent multi-manual processes (=expert-HI PS-1 competency), handle any brand new task with real-time interactive semantic transaction-skills (=expert-HI PS-2 competency), learn newly-updated experience-based knowledge to handle any new task with real-time improved solutions (=expert-HI PS-3 competency) and provide peer-to-peer interactive fine-grained adaptive PS-services (=expert-HI PS-4 competency) to the requestors that can be other strong-AI-PS computing systems with real-time 4 expert-HI PS-competencies.

While a Weak-AI (syntax manual-model)-PS computing system that can only mimic a real world PS-processor with four processor-HI-PS competencies, performs one specific pre-defined manual-task with a series of sequential manual-processes (=processor-HI PS-1 competency), handles any new manual-task with lead-time developed fixated-modelled transaction-skills (=processor-HI PS-2 competency), learns lead-time accumulated knowledge to develop next-version modelled solutions (=processor-HI PS-3 competency) and provides client-server captive coarse-grained reactive PS-services (=processor-HI PS-4 competency) to the clients that can only be zombie-like computing systems even without any Weak-AI PS-competencies.

And the only way for Weak-AI (manual-Model)-PS computing systems to upgrade to Strong-AI (menu-Domain)-PS computing systems is firstly to discover bigger and better hardware architectures with new and better architectural components/methods to upgrade/encapsulate the current hardware architectures, secondly to update the current software theories/methods with these new and better architecture-derived software theories/methods and thirdly to develop new and better hardware and software dually-effected system mechanisms, so that the new and better ensemble AI-PS computing competencies can be achieved, based on all the up-to-the-current developed computing mechanisms that also define what the step-up-growth evolutionary computing advancements really are.

That is to say, the current Weak-AI Model-PS computing paradigm comprising the current hardware architectures, software theories/methods and mechanism disciplines, will have to shift to the new and better Strong-AI computing paradigm with new and better hardware architectures, software theories/methods and mechanism disciplines, so that the new and better Strong-AI Domain-PS system-enabled more sophisticated fine-grained adaptive services can be rendered to replace the current Weak-AI Model-PS system-enabled coarse-grained captive services.

Therefore, the Weak-AI “Model-PS” computing paradigm shift to the Strong-AI “Domain-PS” computing paradigm is inevitable, if bigger and better strong-AI hardware architectures, based on more advanced structural-dimension growth and environmental-encapsulation theories to develop new and better architectural components/methods for upgrading/encapsulating the current Weak-AI hardware architectures, are discovered. And this inevitable Weak-AI-Model-PS to Strong-AI-Domain-PS computing paradigm shift via computing structural growth-based evolutions with new and better computing architectures can be dubbed as a supporting enrichment to Thomas Kuhn's “Scientific Paradigm Shift” via scientific revolutions with new and better theories.

### 2.0 the Current Node-Computing Systems and Nodes-Service-Infrastructures are Only Weak-(Processor)-AI Model-PS Capable.

The current node-computing paradigm (nCP) comprises 2 node architectures (including: von Neumann node-processing architecture-1 and node-networking architecture-2) with subsequently derived node software theories/methods and developed node-system disciplines. In order to achieve the ultimate goal of computing for solving real world service-oriented problems for businesses, consumers and individuals, the nCP needs to implement the following four (4) architectural step-up schemes (including: the current architectural step-up scheme depend on previous existing architectural step-up scheme) for building upward from the basic node-computing systems to a series of nodes-service-infrastructures to accommodate all the real world service-oriented problem domains, based on its only two node architectures.

The four architectural step-up schemes comprise: 1) the first node-architectural step-up scheme (including: node-architectural step-1) is based on the first von-Neumann node-processing architecture-1 to generate node-processors, as shown in FIG. 1; 2) The second node-architectural step-up scheme (including: node-architectural step-2) is to base on the second node-networking architecture-2 to generate nodes-LAN-infrastructures via node-to-node serial network-connections of multiple node-processors, as shown in FIG. 1; 3) the third node-architectural step-up scheme (including: node-architectural step-3) is to still base on the second node-networking architecture-2 to generate nodes-PS-infrastructures via node-to-node serial network-connections of multiple solution-LANs and knowledge-LANs, as shown in FIG. 1; 4) the fourth node-architectural step-up scheme (including: node-architectural step-4) is to still base on the second node-networking architecture-2 to generate nodes-Service-infrastructures via node-to-node serial network-connections of multiple nodes-PS-infrastructures, as shown in FIG. 1.

### 2.1 Node Processors for Achieving Real-Time Multi-Application Sequential Node-AI PS-Processing Competency.

The node-architectural step-1 scheme builds up node-processors with real-time multi-application model-based sequential node-PS-processing competency via the following three workgroup implementations (e.g., hardware/software/mechanism):
1. Node PS-processing Hardware Implementations: Based on the first von Neumann node-processing architecture-1 by using CPUs/GPUs, architectural components primary memory/(DMA components for implementing multi-thread sequential processing methods and multi-level caches components for implementing parallel-accelerating (including: one-application internal multi-thread concurrent-processing) methods, and based on the second node-networking architecture-2 by using architectural components (including: Direct-Access-Memory (DMA)-IO devices and network-DMA IO-devices) for implementing node-networking data-exchange methods, solution-application-based and knowledge-application-based node-processors can be established, as shown in FIG. 1.
2. Node PS-processing Software Implementations: In addition, node-processors can be installed with 1) open-end I&O digital-flow-control network-capable node-OSs and 2) lead-time developed syntax-data-modelled node-application software programs.
3. Node PS-processing (multi-application sequential) Mechanism Implementations: The node-processors are then equipped with hardware and software dual-effect engendered real-time fixated-model multi-application-based sequential-processing mechanism, due to the fact that they only have one primary main memory with DMA capabilities. It then can be used for scheduling both the foreground and background multi-CPU processes in a sequential manner, enabling real-time multi-thread sequential processing capabilities for either solution applications or post-solution knowledge-applications, because both applications for the problem solving cannot be processed at the same time concurrently in one node-processor. Real-time solution-application execution cannot be real-time supervised and contributed by the knowledge-application execution, yielding only real-time multi-application-interface sequential PS-processing mechanism.

After carrying out node-architectural step-1 scheme with four built-in node-computing mechanisms, including: 1) multi-thread uni-node processing mechanism, 2) parallel-accelerating uni-node processing mechanism, 3) node-to-node network-processing mechanism, 4) multi-application sequential uni-node PS-processing mechanism, node-processors are established to engender “a node-PS-processing mechanism event for solving “a” single-node multi-application cascaded PS-processing problem with “an open-end-IO sequential processing result that can be controlled by the node-processor OS and stored in secondary data storage devices, achieving real-time multi-application sequential node-AI PS-processing competency, which is not equal to the multi-application concurrent expert HI-PS-transaction competency and cannot meet the first strong-AI-PS-processing competency requirement.

In summing up, node-processors are created by two uni-node architectures and equipped with three “step-up” digital-computing advancements, including: 1) single node-application multi-thread node-computing, based on DMA (Direct Memory Access) capable IO-devices to augment node-processing architecture, 2) single node-application parallel-accelerating node-computing, based on multi-core multi-level cache devices and concurrent multi-thread methods to augment node-processing architecture and 3) node-to-node application data-exchange-network node-computing, based on data-router/switch DMA-network devices, parallel-accelerating methods and node networking-OSs to augment node-networking architecture. While the fourth multi-application sequential PS-processing mechanism is not a step-up digital-computing advancement, due to the fact that there is no new architectural components, better architectural devices and methods to augment/encapsulate the 2-environmental node-networking architecture-2.

### 2.2 Nodes LAN-Infrastructures for Achieving Real-Time Syntax Node-AI PS-Transaction Competency.

The node-architectural step-2 scheme builds up multi-node-connected nodes-LAN-infrastructures with real-time multi-node-application open-end-cascaded syntax solution & knowledge (S&K) manual-model-based node-AI PS-transaction competency via the following three workgroup implementations (e.g., hardware/software/mechanism):
1. Nodes PS-transaction Hardware Implementations: Based on the first von Neumann node-processing architecture-1 and node-networking architecture-2, two environmental solution-application-based and knowledge-application-based nodes LAN infrastructures can be established by connecting multiple node processors via network OSI-7 protocols, as shown in FIG. 1.
2. Nodes PS-transaction Software implementations: In addition, LAN-nodes can be installed with 1) lead-time developed solution-application-model programs (program-type-1), creating solution LAN for solving problems, such as load-balancing and service-oriented algorithms, 2) lead-time developed post-solution performance management-based knowledge-application model programs (program-type-2), creating knowledge LAN for solving problems, such as Customer Relationship Management (CRM), Enterprise Risk Management (ERM), and 3) lead-time developed database management program (program-type-3), creating the central database server to support both solution-LAN and knowledge LAN, as shown in FIG. 1.
3. Nodes PS-transaction (model-programming) Mechanism Implementations: In so doing, the generated solution as well as knowledge nodes-LANs are equipped with real-time fixated syntax-data multi-node solution-application aggregated server-model-based (syntax-model)-transaction mechanism as well as multi-node knowledge-application aggregated knowledge-server model-based syntax-transaction mechanism, enabling real-time syntax-server fixated model-based PS-transaction capabilities. Therefore, the nodes-PS-transaction mechanism is formed, and can be classified as the fifth node-computing mechanism with multi-node PS-transaction methods.

After carrying out node-architectural step-2 scheme with 5 built-in node-computing mechanisms, including: 1) multi-thread uni-node processing mechanism, 2) parallel-accelerating uni-node processing mechanism and 3) inter application to application inter-node network processing mechanism and 4) multi-application sequential uni-node PS-processing mechanism and 5) syntax-model multi-node PS-transaction mechanism, nodes-LAN-infrastructures are established to engender multiple node PS-Processing mechanism events for solving “a” node-to-node PS-transaction problem with aggregated-application models-based open-end IO-result that cannot be controlled by any node-OS on the LAN-infrastructure, enabling only lead-time node-to-node transaction model-program development based on syntax-data exchanges and achieving real-time syntax-(data-model) node-AI PS-transaction competency, which is not equal to the semantic expert HI-PS-transaction competency and cannot meet the second strong-AI PS-transaction competency requirement.

In summing up, nodes LAN-infrastructures are created based on two uni-node architectures and are equipped with the same three “step-up” digital-computing advancements. The three “step-up” digital-computing advancements comprise: 1) multi-thread computing, 2) parallel-accelerating computing, 3) network-processing computing. It is because the fifth multi-node PS-transaction mechanism is generated based on multi-node network connection and it is not a step-up digital-computing advancement, due to the fact that there is no new and better architecture devices and methods to augment/encapsulate the 2-environmental node-networking architecture-2.

### 2.3 Nodes PS-Infrastructures for Achieving Lead-Time Disrupted Node-AI PS-Collaboration Competency.

The node-architectural step-3 scheme builds up multi-LAN-connected nodes-PS-infrastructures with lead-time cascaded S&K models disrupted node-AI PS-collaboration competency via the following three workgroup implementations (e.g., hardware/software/mechanism):
1. Nodes PS-collaboration Hardware Implementations: Based on the second nodes-networking architecture with network controller devices, 2-environmental nodes-PS infrastructures can be established by connecting multiple nodes-LANs with the central database via network OSI-7 protocols, as shown in FIG. 1.
2. Nodes PS-collaboration Software Implementations: In addition, nodes-tier PS-infrastructures are installed with 1) lead-time developed solution-application server-modelled type-1-programs, 2) knowledge-application server-modelled type-2 programs and 3) common-database management type-3-programs.
3. Nodes PS-collaboration (disrupted PPP)-Mechanism Implementations: In so doing, the generated network-collaborated solution model-PS and knowledge-model-PS tier infrastructures with centralized databases are equipped a lead-time developed/disrupted solution-application-models PS-collaboration mechanism, comprising the following three collaborative Pre-forming, during-Performing and Post-Performance PS-PPP cyclical procedures based on three syntax-manual model application programs, including: 1) solution-application Program-1s, 2) knowledge-application Program-2s and 3) database-management Program-3s.
   i. Pre-Forming (Prompting) Procedures Via the Common Database.

The procedures involve the following 2 procedural methods, they are 1) solution-application Request for Reply (R&R) deliverable pre-forming processing methods via the common database Program-3s and Program-1s; 2) knowledge-application Question for Answer (Q&A) processing methods via the common database Program-3s and Program-2s.

ii. Performing Procedures Via the Common Database.

The performing procedures involve with the following 3 methods. They are 1) solution-application Reply-performing for request processing methods via the common database Program-3s and Program-1s; 2) Solution application Reply performing for request result-(storage) methods via the common database Program-3s and Program-1s; 3) Solution application results return the open-end result to the requester methods via Program-1s.

iii. Performance Procedures Via the Common Database.

The performance procedures are involved with the following 3 methods. They are 1) knowledge-application-model for managing/analyzing/storing solution-(R&R) performance methods via the common database Program-3s and Program-2s; 2) knowledge application data-management methods for facilitating programmers to lead-time develop new-version updated solution-application Program-1s with required conditions via the common database and Program-2s; 3) knowledge-application Answers for question return-to-questioner method via the knowledge application program-2s.

Therefore, the lead-time disrupted S&K models-combined cyclical Pre-forming, Performing, Performance (cyclical-PPP) PS-collaboration mechanism is formed, due to the overall PS-event is discontinued and chopped into disrupted model-version-based PPP PS-collaboration mechanisms and it can be classified as the sixth node-computing mechanism with node PS-collaboration methods. The current Generative Pre-trained Transformer (GPT) for prompting Q&A is just one type of the lead-time disrupted cyclical-PPP PS-collaboration mechanism, which constantly needs new versions to update all the involved large models, such as Large Language Model (LLM) and provides more on the Q&A and less on R&R deliverables.

After carrying out node-architectural step-3 scheme with 6 built-in node-computing mechanism, including: 1) multi-thread uni-node-processing mechanism, 2) parallel-accelerating uni-node processing mechanism, 3) node-to-node network-processing mechanism, 4) sequential uni-node PS-processing mechanism, and 5) multi-node syntax PS-transaction mechanism, and 6) disrupted multi-node PS-collaboration mechanism, nodes-PS-infrastructures are established to engender multiple nodes-PS-transaction mechanism events for solving “a” S&K models PS-collaboration problem with disrupted models-based open-end IO-results that cannot be controlled by any node-OS on the nodes-PS-infrastructure, enabling only lead-time data-solution-model improving and lead-time data-knowledge-model learning capabilities and achieving lead-time disrupted (data-models) node-AI PS-collaboration competency, which is not equal to the expert HI-PS-collaboration services and cannot meet the third strong-AI-PS collaboration competency requirement.

In summing up, Nodes PS-(database)-infrastructures are created by 2 uni-node-architectures and are equipped with the same three “step-up” digital-computing advancements, including: 1) multi-thread computing, 2) parallel-accelerating computing, 3) network-processing computing. It is because the sixth nodes-PS collaboration mechanism is generated based on multi-node network connections and it is not a step-up digital-computing advancement, due to the fact that there is no new and better architecture devices and methods to augment/encapsulate the 2-environmental node-networking architecture-2.

### 2.4 Nodes Service-Infrastructures for Achieving Real-Time Client-Server Interface Node-AI PS-Service Competency

The node-architectural step-4 scheme builds up multi-PS-infrastructure-connected nodes-Service-infrastructures with real-time client-server-interface slave/master-model-based coarse-grained reactive node-AI PS-service competency for servicing clients, via the following three implementations.
1 Nodes PS-service Hardware Implementations: Based on “node-network architecture-2”, 2-environmental nodes-zone/Internet service infrastructures can be formed by connecting multiple nodes-PS-infrastructures with the central database via network OSI-7 protocols, as shown in FIG. 1.
2. Nodes PS-service Software Implementations: In addition, nodes-tier/zone/Internet service-infrastructures are installed with server application programs and client-nodes are installed with client-application programs.
3. Nodes PS-service (client-server-interface) Mechanism Implementations: In so doing, nodes-service-infrastructures are equipped with lead-time developed tier/zone/Internet server-models PS mechanism, enabling real-time pre-developed/fixated tier/zone/Internet client-server application-model-based captive and coarse-grained PS-service capabilities for tier/zone/Internet client-users. Therefore, the nodes-PS service mechanism is formed and it can be classified as the seventh node-computing mechanism with client-server PS-service methods.

After carrying out node-architectural step-4 scheme, based on 7 built-in node-computing mechanisms, including: 1) multi-thread uni-node-processing mechanism, 2) parallel-accelerating uni-node-processing mechanism, 3) node-to-node network-processing mechanism, 4) multi-application sequential uni-node PS-processing mechanism, 5) syntax-model multi-node PS-transaction mechanism, 6) multi-node modelled PS-collaboration mechanism and 7) multi-node PS service mechanism, nodes-service-infrastructures are established to engender multiple nodes-PS-collaboration mechanism events to complete a nodes-PS service for solving “a” nodes-PS-service problem with aggregated-models-based IO-results that cannot be controlled by any node-OS on the service infrastructure, enabling only client-server coarse-grained reactive captive PS-service capabilities and achieving real-time client-server interface node-AI PS-service competency that is not equal to the expert HI-PS services and cannot meet the fourth strong-AI-PS service competency requirement.

In summing up, nodes-service-infrastructures are created based on two uni-node-architectures and equipped with still the same three “step-up” digital-computing advancements, including: 1) multi-thread computing, 2) parallel-accelerating computing, 3) network-processing computing. It is because the seventh nodes PS-service mechanism is generated based on multi-node connections and it is not a step-up digital-computing advancement, due to the fact that there is no new and better architecture devices and methods to augment/encapsulate the 2-environmental node-networking architecture-2

2.5 Conclusions: Node-AI PS is Similar to Processor-HI PS that is Classified as Weak-(Processor)-AI PS for Server-Processors Only.

By the definition of Turing Test, the current nodes-service-infrastructures are equipped with 4 node-computing AI-PS competencies, including: 1) real-time multi-application sequential node-AI PS-processing, 2) real-time syntax-model node-AI PS-transactions, 3) lead-time disrupted S&K application modelled node-AI PS-collaborations, and 4) real-time client-server captive coarse-grained-reactive (CGR) fixated-modelled node-AI PS-services, which are clearly inferior to the 4 expert-HI PS-competencies that are possessed by a real world PS-expert.

In fact, nodes-service-infrastructures can only mimic a group of real world PS-processors that can carry out only a specific pre-set fixated syntax-manual model-based Coarse-Grained-Reactive (CGR) PS-service to captive clients. They cannot carry out what a real world PS-expert can do to provide a plurality of real-time peer-to-peer feedback-interactive Fine-Grained Proactive (FGP) adaptive PS-services to any requestor. Therefore, all the nodes-service-infrastructures should be deemed as Weak-AI-PS competent.

Most importantly, there are at least three (3) unresolvable limitations behind weak-AI node-computing systems/infrastructures in solving real world service-oriented problems. They are 1) due to only two uni-node-architectures, there are no multi-node architectural tools/devices and methods to build up bigger structural-systems with better PS-capabilities to encapsulate real world service-oriented problem domains, from the smallest multi-function production domains, to multi-production assembly domains, to multi-assembly fabrication domains, to multi-fabrication transaction domains, to multi-transaction business service domains, to multi-business consumer service domains and to multi-consumer individual service domains. 2) due to only two uni-node-architectures, there is no built-in hierarchical control over the PS results when the service-oriented problem domain is larger than node-processing system domain. Therefore, the PS-event is not processes-integrated as one, but it is combined with multiple uncontrollable processes-aggregated events. Therefore, the PS-results cannot be retriggered for real-time improvement and may cause undesired and even dire consequences. 3) due to only two uni-node-architectures, the client-server interface services are generated by the servers that cannot control the PS-service results and can only output to clients without any feedback checks to see if they meets client's requirements.

### 3.0 the First Task-Expert Workgroup Service Systems are Strong-(Expert)-AI Domain-PS Capable.

In order to resolve the limitations of node-computing systems and infrastructures, the present invention is focused on four workgroup architectures with architectural components/devices/methods, where the first two workgroup architectures are the enhancements of the two uni-node architectures, including: 1) workgroup-node-processing architecture-1 via enhanced node-von Neumann architecture with additional workgroup-processing devices, such as TeamServers and TeamPanels, as shown in U.S. Pat. No. 5,802,391 and 2) workgroup-node networking architecture-2 via enhanced node-networking architecture with new workgroup-node network-controllers, such as TeamProcessors, as shown in US-Patent number #6,715,100. The next two workgroup architectures are 3) 3-level workgroup linkage type-1 (WL1) aggregation multi-workgroup-node architecture-3 with WL1-aggregation-Controllers and 4) 3-level hierarchical workgroup linkage type-2 (WL2) integration multi-workgroup-node architecture-4 with WL2-(direct-access)-TeamServers, as shown in U.S. Pat. No. 11,132,236.

Based on these four workgroup architectures, the workgroup PS-expert system can be established for accommodating real-world service-oriented problem solving via the following four workgroup architectural step-up schemes, (including: the current architectural step-up scheme that depends on the previous existing architectural step-up scheme), to build upward starting from workgroup Basic-Building Blocks (wBBBs) to workgroup system-level structures.

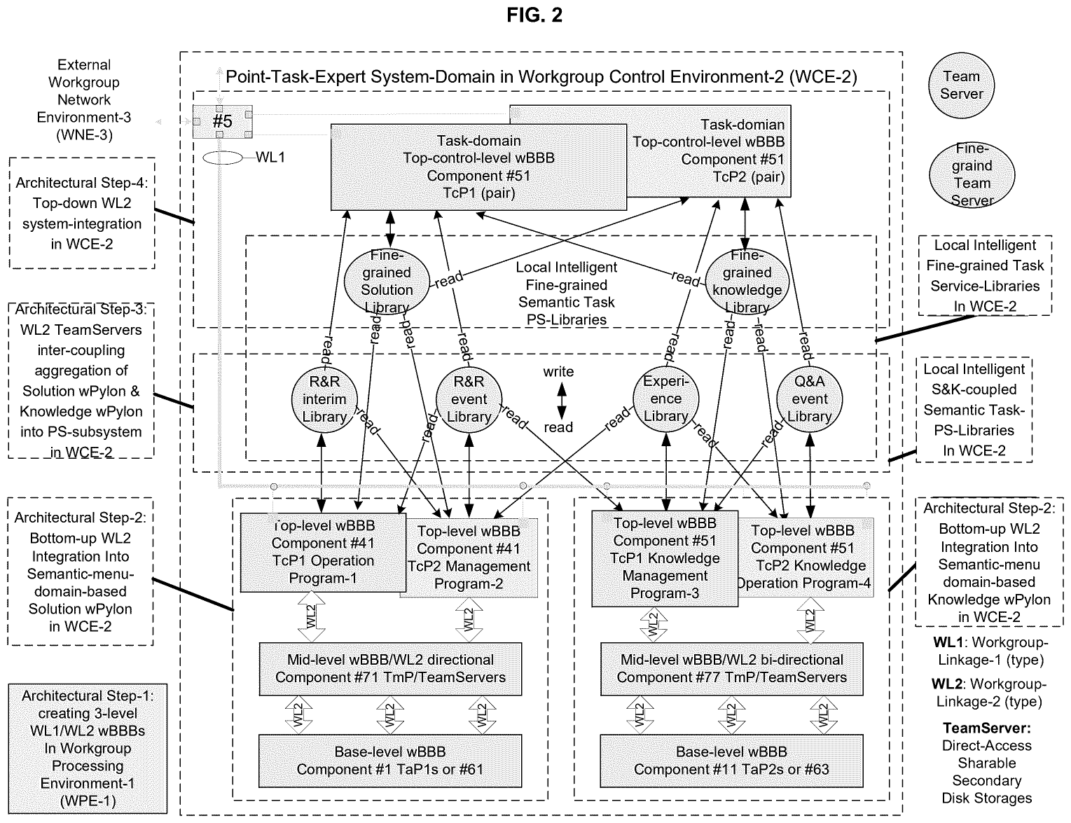

FIG. 2 is a block diagram depicting an exemplary embodiment of the current disclosure of the first real-time feedback-control-based Point-closed-loop multi-application-integrated Strong-AI Point task-expert workgroup service system, equipping a computing environment with seven computing advancements, according to at least one embodiment of the present invention.

The four workgroup architectural step-up schemes comprise 1) the first workgroup-architectural step-up scheme (including: workgroup-architectural step-1) is based on workgroup architecture-1 to workgroup architecture-4 with structural and environmental architectural-theories, workgroup link TeamServer and TeamProcessors architectural components/devices and WL1/WL2-aggregation architectural methods to generate base-level, mid-level and top-level WL1/WL2 direct-access wBBBs, as shown in FIG. 2; 2) The second workgroup-architectural step-up scheme (including: workgroup-architectural step-2) is to base on workgroup architecture-4 to generate workgroup pylons (Solution and Knowledge) wPylon via 3-level wBBBs with bottom-up WL2-integration, as shown in FIG. 2; 3) The third workgroup-architectural step-up scheme (including: workgroup-architectural step-3) is to base on workgroup architecture-4 to generate workgroup PS subsystem (PS-oriented wSubsystem) via wPylons with inter-memory-coupled WL2-aggregation, as shown in FIGS. 2; and 4) The fourth workgroup-architectural step-up scheme (including: workgroup-architectural step-4) is to base on WL1/WL2 workgroup architecture-3 and workgroup architecture-4 to generate feedback-control service-oriented workgroup expert service systems via PS-wSubsystem(s) with 2-level top-down wBBBs WL2-integration, as shown in FIG. 2.

The details on how these four workgroup architectural step-up (implementation) schemes with subsequently architecture-derived three (3) hardware/software mechanism implementations, can achieve the four workgroup-computing Artificial-Intelligent Problem-Solving (workgroup-AI PS) competencies outlined by the Turing Test, are discussed as follows.

3.1 Workgroup BBBs (wBBBs) for Achieving Real-Time Multi-Application Concurrent Workgroup-AI PS-Processing Competency.

The workgroup-architectural step-1 (implementation) scheme builds up 3-level workgroup Basic Building Blocks (wBBBs) with real-time concurrent workgroup AI PS-processing competency via the following three workgroup implementations (e.g., hardware/software/mechanism):

### 1. Workgroup PS-processing Hardware Implementations:

Based on the workgroup 3-level WL1-aggregation architecture-3 and workgroup 3-level WL2-integration architecture-4 by using architectural components, such as “direct-access-WL2” TeamServers and WL1/WL2-TeamProcessors, 3-level wBBBs can be established, as illustrated in FIG. 2. TeamServers are sharable secondary disk storage (e.g., imagined it as a common working area/table) that allows multiple TeamProcessors to concurrently to share via direct-access WL2 linkages, creating a new and better security-protection-based workgroup-collaboration/control environment-2 (WCE-2) that is an addition to each TeamProcessor's internal processing environment, including: workgroup processing environment-1 (WPE-1), which is created based on internal-private direct-access primary main-processing memory and direct-access private/non-sharable secondary disk storages. The details of TeamServers and TeamProcessors are illustrated in U.S. Pat. No. 5,802,391, and the details of multiple TeamServers/TeamProcessors integrated Workgroup server Array for building wBBB are illustrated U.S. Pat. No. 6,715,100.

Moreover, each-level wBBB are built-in with internal TeamServers, including: internal common working area for multiple TeamProcessors that can concurrently carry out the same applications for enabling real-time fail-over capabilities as well as different applications for enabling real-time multi-application merged effects on each application with real-time interactive self-enhancement in the same multi-application event, due to the common working area/table. For example, the multiple applications can constant interact on the TeamServer in the same event, so that the multi-application-integrated results can be continuously self-updated and self-improved.

### 2. Workgroup PS-processing Software Implementations:

In addition, wBBBs are installed with 3-level wOSs for TeamProcessors, including: waOS for base-level Team-attribute Processors (TaPs), wtOS for mid-level-traffic Team-memory Processors (TmPs) and wcOS for top-level-control Team-control Processors (TcPs) with external workgroup semantic-networking capabilities, creating the third workgroup network/open environment-3 (WNE-3), as illustrated in FIG. 2. Moreover, top-level paired TcP1 and TcP2 can be installed with real-time dynamic semantic-sentential Operation and Management programs, as illustrated in US workgroup-software patent.

### 3. Workgroup PS-processing Mechanism Implementations:

In so doing, these 3-level wBBBs are equipped with “real-time homo-hetero concurrent PS-processing mechanism based on internal TeamServer, (e.g., hardware, software, combined H&S/dually-effected) H&S mechanism, due to the fact an internal TeamServer is equipped with the secondary storage direct-access sharing capabilities that allow all the connected homo/hetero TeamProcessors to concurrently execute the processes in a real-time manner.

Moreover, wBBBs are built-in with PS-processing mechanism result control capabilities. It is because workgroup-node wOS/programs can control the real-time workgroup processing mechanism results for real-time (dynamic)/adaptively solving the workgroup application problems with all the better workgroup processing effects, such as 1) real-time mutual upgrading results; 2) real-time self-improving results; and 3) real-time retriggering PS-processing event.

Most importantly, these better workgroup PS-processing effective results can be stored in the local wOS-direct-access TeamServers as the current workgroup processing experiences, for re-triggering the mechanism until the final current best effective-results are achieved, prolong the mechanism event until the most feasible effective resulted experiences are obtained. Therefore, it is inevitable that the fourth new and better workgroup PS-processing mechanism will replace the current node PS-processing mechanism and it can be classified as the fourth step-up computing advancement in the digital computing historical context.

After carrying out workgroup-architectural step-1 scheme, based on four built-in workgroup-computing mechanisms, including: 1) multi-thread workgroup-node processing mechanism, 2) parallel-accelerating workgroup-node processing mechanism, 3) workgroup nodes network processing mechanism, and 4) workgroup concurrent PS-processing mechanism. wBBBs are established to engender “one” long-running workgroup PS-processing mechanism event for solving “any” multi-application concurrent workgroup PS-processing problem with the most feasible workgroup-processing result that can be controlled and stored into internal secondary storages by each wBBB TeamProcessor wOS, enabling the above-mentioned workgroup-processing effects and achieving real-time concurrent workgroup-AI PS-processing competency, which is equal to expert-HI PS-processing competency and meets the first strong-AI PS-processing competency requirement.

In summing up, the wBBBs are created based on four workgroup architectures and equipped with four “step-up” digital-computing advancements, including: 1) multi-thread processing computing, 2) parallel-accelerating processing computing, 3) OSI-7 data-network processing computing, 4) multi-application concurrent processing computing, due to the fourth-workgroup PS-processing mechanism.

3.2 Workgroup Pylons (wPylons) for Achieving Real-Time Semantic Domain Workgroup-AI PS-Transaction Competency.

The workgroup-architectural step-2 (implementation) scheme builds up wPylons with real-time multi-workgroup application-models closed-loop-integrated semantic (S/K)-domain workgroup-AI PS-transaction competency, via the following three workgroup implementations (e.g., hardware/software/mechanism):

### 1. Workgroup PS-transaction Hardware Implementations:

The solution and knowledge (S&K) wPylons in three computing environments can be established based on the inter-coupling WL2 aggregation workgroup hardware architecture-4 by using mid-level internal TeamServers as the external common working area for base-level wBBB and top-level wBBB, as shown in FIG. 2. Moreover, the top-wBBBs, each paired TcPs can be equipped with “internal TeamServers” for enabling closed-loop multi-solution-application menu-operation and multi-knowledge application menu-management interaction, enabling real-time dynamic domain O&M programming.

### 2. Workgroup PS-transaction Software Implementation:

In addition, wPylon can be installed with 1) real-time semantic solution operation and management programming mechanism, creating solution semantic-domain, illustrated by solution TcP1 and TcP2 and solution-event performing-result-based solution libraries, and 2) real-time semantic knowledge operation and management programming mechanism, creating “knowledge semantic domain”, illustrated by knowledge TcP1 and TcP2 and solution-event performance-experience-based knowledge-libraries, as shown in FIG. 2.

### 3. Workgroup PS-transaction Mechanism Implementations:

In so doing, the architected solution as well as knowledge wPylons are equipped with 1) real-time better domain security mechanism and 2) real-time dynamic” manual/menu domain programming mechanisms, where 1) real-time better solution and knowledge domain security mechanism is created due to the fact that the second workgroup internal-concurrent collaborative-processing environment-2 is created, so that external menu-level requests received from the third workgroup external network-processing environment-3 won't direct affect the manual-level processes in the first workgroup internal-processing environment-1, and 2) real-time dynamic domain programming mechanism is created due to the fact that “bottom-up-meta-first compiler and top-down-meso-second compiler create a closed-loop and bug-free real-time dynamic manuals-to-menu and menu-to-manuals solution domain, which is full of real-time dynamically generated as well as pre-generated semantic solutions that are/were meta-compile the result from 3-level closed-loop routed pathways over the pool of base-level syntax-processing-application models.

In addition, when the request-requirement-matched semantic solution is selected by the top-level solution operation-program, it can be then meso-compiled into the right routed pathway to trigger all the involved syntax-data solution-application program-models, get the closed-loop pathway result that can be meta-compiled into semantic-terms and replied back to the requestor by the top-level solution operation-program. During the triggering, if the request-requirement is changed due to top-level concurrent solution management program's request reacted to the external requestor's new requirements as well as internal human-controller's commands, then a new route can be re-selected to retrigger the subsequently involved syntax-data solution application models in the pool and obtain the new closed-loop pathway result that can be meta-compiled into new semantic solution terms stored in the updated menu-repository and replied back to the requestor by the top-level solution-operation program. Solution domain is full of semantic-term menu-solutions that comprise a series of existing syntax-data processing manual-models on a route and meta-compile the dataset result into a semantic term.

Equally in the same way, a knowledge domain resided on a wPylon can also be established among syntax-data knowledge-application program-models, concurrent semantic-term knowledge-operation programs and concurrent semantic-term knowledge management programs. The details are illustrated in U.S. Pat. No. 11,797,299.

Moreover, wPylons are built-in with PS-transaction mechanism result control capabilities. It is because top-level TcP1/TcP2 wOSs/programs can closed-loop-control the real-time dynamic programming mechanism results for real-time (dynamic)/adaptively solving the workgroup-node-to-workgroup-node domain-transaction problems with better workgroup transaction effects, such as 1) real-time dynamic semantic menu-programming without bugs, 2) real-time retriggering the PS-transaction event.

Most importantly, these better workgroup transaction-effective results can be stored in the local wOS-direct-access TeamServers as the current experience, for re-triggering the PS-transaction mechanism until the final current best effective-results are achieved, prolong the PS-transaction mechanism event until the most feasible effective resulted PS-transaction experiences are obtained for blueprinting the next upcoming PS-transactions. Therefore, it is inevitable that the fifth new and better semantic-domain workgroup PS-transaction mechanism will replace the current syntax-model nodes-PS-transaction mechanism and it can be classified as the fourth step-up computing advancement in the digital computing historical context.

After carrying out workgroup-architectural step-2 implementation scheme with 5 built-in workgroup computing mechanisms, including: 1) multi-thread workgroup-node processing mechanism, 2) parallel-accelerating workgroup-node processing mechanism, 3) workgroup nodes network processing mechanism, 4) workgroup concurrent PS-processing mechanism and 5) workgroup semantic domain PS transaction mechanism, 3-level wPylons are established to engender one long-running workgroup PS-transaction mechanism event for concurrently/continuously solving “any” 3-environmental workgroup solution/knowledge domain PS-transaction problem with the most feasible workgroup transaction result that can be closed-loop controlled and stored into solution-(R&R)-libraries and knowledge-(Experience and Q&A)-libraries by top-level domain TcP1/TcP2 as shown in FIG. 2, enabling the above-mentioned workgroup-transaction effects and achieving real-time semantic workgroup-AI PS-transaction competency, which is equal to expert-HI PS-transaction competency and meets the second strong-AI PS-transaction competency requirement.

In summing up, the wPylons are created based on 4 workgroup architectures and equipped with 5 “step-up” digital computing advancements, including: 1) multi-thread processing computing, 2) parallel-accelerating processing computing, 3) OSI-7 data-network processing computing, 4) multi-application concurrent processing computing, 5) semantic-domain transaction computing, due to the fifth workgroup PS-transaction mechanism.

3.3 Workgroup PS-Subsystems (wSubsystems) for Achieving Real-Time Automated Workgroup-AI PS-Collaboration Competency.

The workgroup-architectural step-3 (implementation) scheme builds up workgroup PS-subsystems with real-time S&K domains coupled PS-domain automated workgroup AI PS-collaboration competency, via the following three workgroup implementations (e.g., hardware/software/mechanism):
1. Workgroup PS-collaboration Hardware Implementations: Based on the inter-coupling WL2 aggregation workgroup hardware architecture-4 by using TeamServer-coupling, solution and knowledge (S&K) workgroup inter-pylon-subsystem in 3 computing environments can be established, as shown in FIG. 2.
2. Workgroup PS-collaboration Software Implementations: In addition, this subsystem containing solution domain-mechanism and knowledge domain mechanism can be further installed with PS-collaboration 4-type programs, including: semantic solution-operation-programs-type-1 and semantic solution-management-programs-type-2, and semantic knowledge-management-programs-type-3 and semantic knowledge-operation-programs-type-4, all of which can utilize coupled TeamServers-created real-time “self-updating local-intelligent semantic libraries” for real-time semantic PS information exchanges, as illustrated in FIG. 2.
3. Workgroup PS-collaboration Mechanism Implementations: In so doing, the created solution-domain and knowledge-domain wPylons-coupled workgroup subsystem is equipped with real-time automated “Task-Domain” PS-collaboration mechanism implementation, comprising the following three collaborative (Pre-forming, Performing, Performance (PS-PPP) cyclical-procedures based on four semantic menu-domain sentential-programs, including: solution operation TcP1 Program-1s, solution management-TcP2 Program-2s, knowledge management-TcP1 Program-3s, and knowledge operation-TcP2 Program-4s.
   i. Pre-forming Procedures:

The Pre-forming procedures involve 2 procedural methods. They are 1) real-time solution-domain TcP1 Request for Reply (R&R) operation method via local intelligent PS-libraries and solution-sentential operation Program-1.2) real-time knowledge-domain TcP2 Question for Answer (Q&A) operation method via local intelligent PS-libraries and knowledge sentential-operation Program-4.

ii. Performing Procedures:

The performing procedures involve four procedural methods. They are 1) real-time Solution domain Program-2 request for the current best experience method via common local PS-libraries with knowledge-domain Program-3 support. 2) real-time solution domain Program-1 Reply for Request operation method via the common local PS-libraries and Program-2 support. 3) real-time solution domain Program-1 Reply for request real-time management method via the common local PS-libraries and Program-2 support. 4) real-time Solution domain Program-1 WL1/WL4 communication method to send the requestor with R&R results.

iii. Performance Procedures:

Performance procedures involve the following three procedural methods. They are 1) real-time knowledge-domain TcP1 R&R result management method via common local PS-libraries and knowledge sentential management Program-3, to generate new-updated menu-item-based templates and the current best experiences under different criteria; 2) real-time knowledge-domain TcP2 Answer for Question operation method via common local PS-libraries and knowledge sentential operation Program-4, for real-time provide external Q&A with the current best experiences with criteria to match with requestor's requirements; 3) real-time knowledge-domain Program-4 operation management method via common PS-libraries and knowledge sentential management Program-3; 4) real-time knowledge-domain WL1/WL4 communication method via knowledge sentential operation Program-4 to send the requestor with PS-event experience-information.

Therefore, the real-time automated solution domain and knowledge domain coupled cyclical-PPP PS-collaboration mechanism is formed. Due to these four semantic solution operation/management and knowledge management/operation programs involved 3 PS-event procedures can be iteratively repeated, the real-time automated PS-event 3-procedure-cycle, including: 1) from pre-solution event forming via solution-TcP1 R&R-operation Program-1 and knowledge-TcP2 Q&A-operation Program-4, 2) to solution-TcP1 event performing R&R-operation Program-1 and real-time solution-TcP2 performing-management program-2, 3) to real-time solution-event performance knowledge-TcP1 PS-experiences management Program-3 and real-time PS-experiences knowledge-TcP2 Q&A operation Program-4, can be formed. Hence, the current Pre-during-post Task-domain PS-event 3-procedure-cycle with newly learned knowledge experiences can enable the next Pre-during-post 3-procedure-cycle with the best feasible solutions based on newly learned experiences, and this 3-procedure-cycle can keep on going without disruption.

This real-time automated semantic Solution & Knowledge (S&K) domains PS-collaboration mechanism can accommodate the next upcoming problem-solving-task with the real-time negotiable the pre-forming based on already-updated solution-menu items that are associated with the current best knowledge experiences-dictated multi-manual closed-loop routed-processing semantic/syntax solution-processes, including: the closed-loop semantic-menu R&R/Q&A-PS-event long-running process comprises multiple syntax-manual IO-PS-events' processes that are sequentially routed. That is to say that the Task-domain is full of real-time selectable closed-loop solution-routes and knowledge-routes for real-time dynamic problem solving, as long as the problem domain is smaller than the Task PS-domain.

Moreover, PS-collaborative wSubsystems are built-in with PS-collaboration mechanism result control capabilities. It is because S&K domains' top-level TcP1/TcP2 wOSs/Programs can control the real-time dynamic programming mechanism results for real-time dynamically solving the domains-collaboration problems with better workgroup collaboration effects, such as 1) real-time solution-domain self-improving, 2) real-time knowledge domain self-learning and 3) real-time retriggering the PS-collaboration event.

Most importantly, these better workgroup transaction-effective results can be stored in the local wOS-direct-access PS-libraries as the current experience, which can be used for re-triggering the workgroup PS-collaboration mechanism until the final current best effective-results are achieved, prolong the PS-collaboration mechanism event until the most feasible effective resulted PS-collaboration experiences are obtained. In addition, due to the fact that coupled TeamServer based semantic-libraries are located inside the subsystem for building up real-time local PS-intelligence to support real-time solution improving and knowledge-learning and there is no need for data/information centralization, because no matter how large and centralized it could be, it is still functioned as one of the many locals. Therefore, it is inevitable that the new and better real-time automated workgroup-PS collaboration mechanism will replace the current lead-time disrupted nodes-PS-collaboration mechanism and it can be classified as the sixth step-up computing advancement in the digital computing historical context.

After carrying out workgroup-architectural step-3 scheme, based on 6 built-in workgroup-computing mechanisms, including: 1) multi-thread workgroup-node processing mechanism, 2) parallel-accelerating workgroup-node processing mechanism, 3) workgroup nodes network processing mechanism, 4) workgroup concurrent PS-processing mechanism, 5) workgroup semantic domain PS transaction mechanism and 6) workgroup PS-collaboration mechanism, task-expert workgroup subsystems are established to engender one long-running workgroup PS-collaboration mechanism event for concurrently solving “any” S&K domains-coupled workgroup PS-collaboration problem with the most-feasible workgroup collaboration result that can be controlled and stored into semantic Task PS-libraries by S&K domains' TcP1/TcP2 as shown in FIG. 2, enabling the above-mentioned workgroup PS-collaboration effects and achieving real-time automated workgroup-AI PS-collaboration competency, which is equal to the expert-HI PS-collaboration competency and meets the third strong-AI PS-collaboration competency requirement.

In summing up, the wSubsystems are created based on 4 workgroup architectures and equipped with 6 “step-up” digital-computing advancements, including: 1) multi-thread processing computing, 2) parallel-accelerating processing computing, 3) OSI-7 data-network processing computing, 4) multi-application concurrent processing computing, 5) semantic-domain transaction computing, 6) collaborative-domains automation computing, due to the sixth workgroup PS-collaboration mechanism.

3.4 Workgroup Service Systems (wSystem) for Achieving Real-Time Peer-to-Peer Interactive Workgroup-AI PS-Service Competency.

The workgroup-architectural step-4 scheme builds up the first workgroup service System (wSystems) with real-time peer-to-peer interactive (S&K)-PS-domains-based fine-grained-proactive workgroup-AI PS-service competency for servicing all-involved parties, via the following three workgroup implementations (e.g., hardware/software/mechanism):
1. Workgroup PS-service Hardware Implementations: Based on the top-down WL2 hierarchical-integration hardware architecture by using integrable top-level feedback-control WSAs (component #51) and mid-level traffic-control WSAs (component #85) on top of base-level workgroup PS-collaboration subsystems, to generate workgroup task-expert-systems in 2 computing environments, as shown in FIG. 2.
2. Workgroup PS-service Software Implementations: In addition, the workgroup Expert System can be installed with workgroup fine-grained service-oriented problem-solving software that is supported by the workgroup solution-domain O&M software programs and knowledge domain O&M software programs coupled workgroup Task-domain PS-collaboration software programs.
3. Workgroup PS-service Mechanism implementations: In so doing, the created task-expert wSystem is equipped with real-time “feedback-control” (due to hardware architecture) and “interactive semantic R&R and semantic Q&A (due to software) (system)-mechanisms, where feedback-control system-mechanism is created due to top-level paired-TeamProcessors/WSA (component #91) with their direct-access-TeamServers to couple with solution and knowledge wPylons' (component #170) direct-access TeamServers, establish the real-time fine-grained local self-improving/self-learning intelligent semantic-libraries (as shown in the FIG. 2) with top-down feedback-control mechanism.

Moreover, task-expert wSystems are built-in with PS-service mechanism result control capabilities. It is because system-domain's top-level TcP1/TcP2 wOSs/programs can feedback-control the real-time dynamic PS-service mechanism results for real-time adaptively solving the production service-oriented problems with better workgroup service effects, such as 1) real-time peer-to-peer interactivity, 2) real-time fine-grained proactivity and 3) real-time retriggering the PS-service event.

Most importantly, these better workgroup transaction-effective results can be stored in the local fine-grained libraries as the current experience, for further re-triggering the PS-service mechanism until the final current best effective-results are achieved, prolong the PS-service mechanism event until the most feasible effective resulted PS-service experiences are obtained. Therefore, it is inevitable that the seventh new and better workgroup PS-service mechanism will replace the current client-server nodes-PS-service mechanism and it can be classified as the seventh step-up computing advancement in the digital computing historical context.

After carrying out workgroup-architectural step-4 scheme with 7 built-in “controllable” workgroup-computing mechanisms, including: 1) multi-thread workgroup-node processing mechanism, 2) parallel-accelerating workgroup-node processing mechanism, 3) workgroup nodes network processing mechanism, 4) workgroup concurrent PS-processing mechanism, 5) workgroup semantic domain PS transaction mechanism, 6) workgroup PS-collaboration mechanism and 7) workgroup PS-service mechanism, task-expert workgroup service systems are established to engender one long-running workgroup PS-service mechanism event for “continuously” solving “any” 3-environmental workgroup PS-service problem” with the most-feasible workgroup-service result that can be feedback-controlled and stored into fine-grained semantic Task PS-libraries by system TcP1/TcP2 as shown in FIG. 2, enabling the above-mentioned workgroup service effects and achieving real-time peer-to-peer interactive workgroup-AI PS-service competency, which is equal to the expert HI PS-service competency and meets the fourth strong-AI PS-service competency requirement.

In summing up, the task-expert workgroup service systems are created based on 4 workgroup architectures and equipped with 7 “step-up” digital computing advancements, including: 1) multi-thread processing computing, 2) parallel-accelerating processing computing, 3) OSI-7 data-network processing computing, 4) multi-application concurrent processing computing, 5) semantic-domain transaction-computing, 6) collaborative-domains automation computing and 7) peer-to-peer feedback-interactive service computing, due to the seventh workgroup PS-service mechanism.

3.5 Conclusion: Workgroup-AI PS is Similar to Expert-HI PS that is Defined as Strong-(Expert)-AI-PS for Every Involved Expert Party.

By the definition of Turing Test, the present task-expert workgroup service system is equipped with 4 workgroup-computing AI-PS competencies, including: 1) real-time concurrent-application workgroup-AI PS-processing, 2) real-time semantic domain workgroup-AI PS-transactions, 3) real-time automated S&K-domains workgroup-AI PS-collaborations, and 4) real-time peer-to-peer interactive fine-grained-proactive workgroup-AI PS-services, which are equal to the four (4) expert-HI PS-competencies, including: 1) real-time concurrent expert-HI PS-processing, 2) real-time semantic (menu-domain) expert-HI PS-transactions, 3) real-time automated expert-HI PS-collaborations and 4) real-time interactive (fine-grained adaptive) expert-HI PS-services, which are possessed by a real world PS-expert.

This first Workgroup service-system can mimic a real world production-PS-expert and carry out all the multi-modelled-application-integrated tasks that a production PS-expert has to accomplish. It can real-time concurrent process multiple workgroup homo/hetero applications (workgroup-AI-PS-1), real-time handle any brand new task-request with real-time semantic interactive workgroup domain PS-skills (workgroup-AI-PS-2), real-time utilize knowledge learning to solve any task-problem with real-time improved solutions via automated workgroup-task-domain PS-collaborations (workgroup-AI-PS-3) and provide real-time peer-to-peer user-centric interactive fine-grained-adaptive workgroup system domain-based PS-services (workgroup-AI-PS-4). Therefore, the present inventive the first workgroup service systems, dubbed the first task-expert workgroup production service system is deemed Strong-AI-PS competent.

4.0 the First Task-Expert Workgroup Service Systems can Evolve with Multi-Stage Structural Growth in the First Workgroup-Production Evolutionary Generation, Due to Multi-Node Dimensional Parameters.

The task-expert workgroup service systems are basically the simplest, due to the fact that they have top-level single Pair-TeamProcessors to control over concurrent mid-level and base-level WSAs, which contain a plurality of TeamServer and TeamProcessor architectural components that can enable further multi-stage structural dimensional growth.

In order to simplify the description of the inner-workings of four workgroup architectural step-up schemes, “functional blocks” may be used to contain all the key TeamServer and TeamProcessor integrated components with identified numbers and “WL1/WL4 architectural device linkages” to show the connections among functional blocks without showing the detailed TeamProcessor and TeamServer component-to-component connections, because all the detailed connections are already disclosed in related drawings of the U.S. Pat. No. 11,132,236. By doing so, the inner-workings of four architectural implementation methods, that enable multi-stage structural growth, can be displayed and analyzed in a more legible manner. There are at least five stages of evolutionary growths in the first workgroup evolutionary generation (wG1) of the task-expert workgroup production systems and the details are discussed as follows.

### 4.1 wG1.Stage-1 (wG1.1) Evolutionary Growth in Building Up Strong-AI 1D Task-Expert Workgroup Production Service Systems.

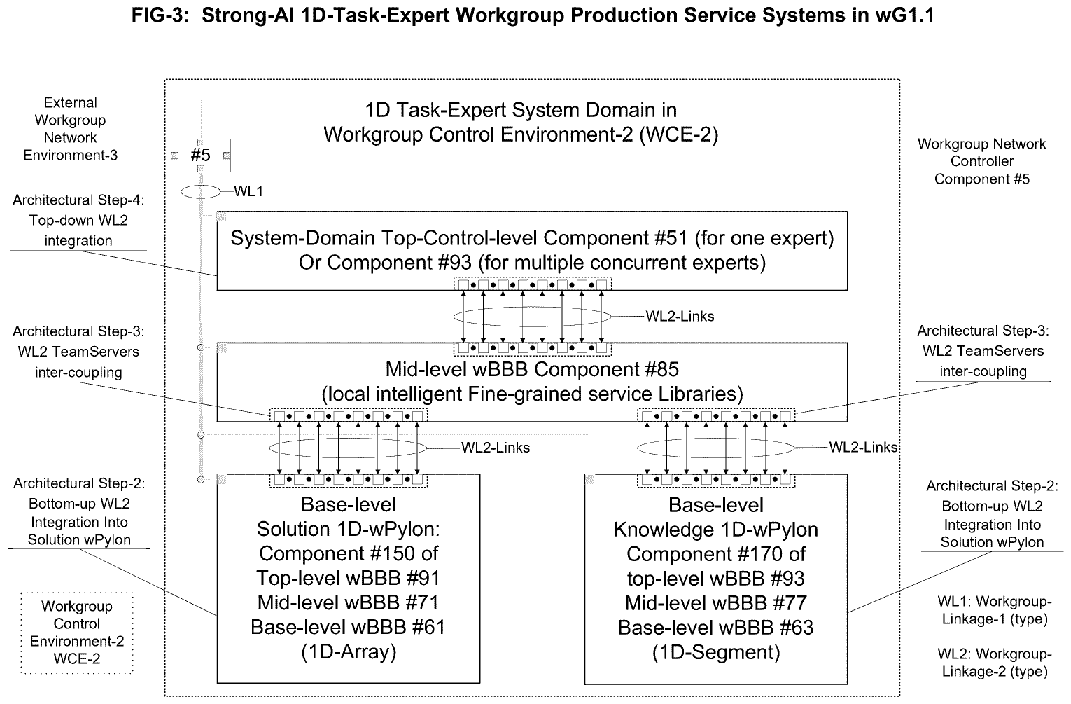

FIG. 3 shows a real-time 1D-concurrent feedback-control-based 1D closed-loop multi-application integrated strong-AI 1D task-expert workgroup production service system, equipping a computing environment with seven computing advancements, according to at least one embodiment of the present invention. As shown in FIG. 3, there are four wG1.1 workgroup architectural step-up (step-1 to step-4) hardware growth from the first point task-expert workgroup production service system into 1D task-expert workgroup production service systems in the first stage of the first workgroup evolutionary generation (wG1.1). They are 1) the wG1.1 architectural step-1 hardware growth generates a) 3-level solution-1D-wBBBs, which can grow from base-wBBB #61, mid-wBBB #71 and single-pair top-wBBB as shown in FIG. 2, into 1D-base-wBBB #61, 1D-mid-wBBB #71 and 1D-top-wBBB #91 and b) 3-level knowledge-1D-wBBBs, which can grow from base-wBBB #63, mid-wBBB #77 and single-pair top-wBBB as shown in FIG. 2, into 1D-base-wBBB #63, 1D-mid-wBBB #77 and 1D-top-wBBB #93; 2) the wG1.1 architectural step-2 hardware growth generates a) solution 1D-wPylon #150 and b) knowledge 1D-closed-loop wPylon #170; 3) the wG1.1 architectural step-3 hardware growth generates 1D-subsystem that comprises 1D solution wPylon inter-coupled with 1D knowledge wPylon via WL2; 4) the wG1.1 architectural step-4 hardware growth generates 1D task-Expert workgroup production service system that comprises Top-level wBBB #51 or #93, mid-level wBBB #85, base-level Solution wPylon #150 and base-level knowledge wPylon #170.

Therefore, after carrying out wG1.1 four workgroup architectural step-up implementation schemes with 7 built-in workgroup computing mechanisms, 1D task-expert workgroup production service systems can evolve into existence, achieving real-time peer-to-peer negotiable workgroup-AI PS-service competency that is equal to the expert HI PS-service competency and meet the fourth strong-AI PS-service competency requirement.

In addition, each 1D task-expert system-domain can accommodate an array of expert-TcPs, i number of 1D-Array-solution-TeamProcessors (TaPs) and j number of 1D-segment knowledge-TeamProcessors (TaPs) to accesses the local intelligent libraries for encapsulating 1D-complex production problem-domain with real-time concurrent 1D-workgroup AI-PS capabilities, based on architectural parameters' (i and j) expansion in positive integer counting numbers.

In summing up, the 1D task-expert workgroup production service systems are created based on four workgroup architectures and equipped with 7 “step-up” digital-computing advancements, including: 1) multi-thread processing computing, 2) parallel-accelerating processing computing, 3) OSI-7 data-network processing computing, 4) multi-application concurrent processing computing, 5) semantic-domain transaction-computing, 6) collaborative-domains automation computing and 7) peer-to-peer feedback-interactive service computing.

### 4.2 wG1.Stage-2 (wG1.2) Evolutionary Growth in Building Up Strong-AI 2D Task-Expert Workgroup Production Service Systems.

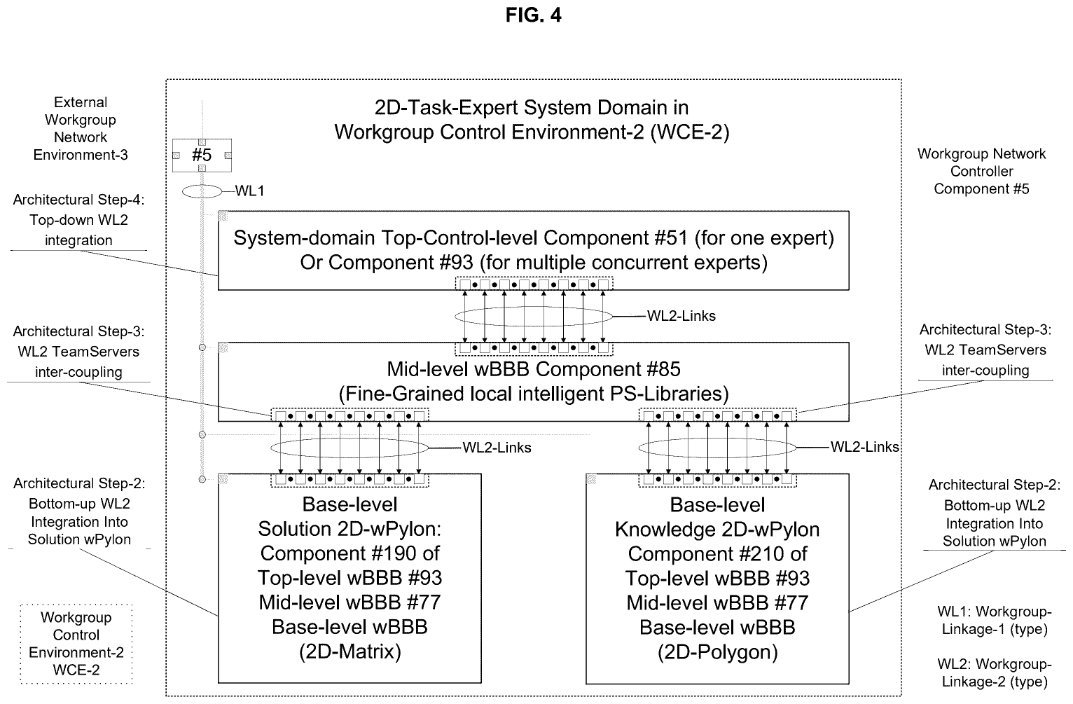

FIG. 4 is a block diagram depicting an exemplary embodiment of the current disclosure of a real-time 1D concurrent feedback-control-based 2D closed-loop multi-application-integrated Strong-AI 2D task-expert workgroup production service system, equipping with seven computing advancements, according to at least one embodiment of the present invention. As shown in FIG. 4, there are four wG1.2 workgroup architectural step-up hardware growth from 1D task-expert workgroup production service systems into 2D task-expert workgroup production service systems in the second stage of the first workgroup evolutionary generation. They are 1) the wG1.2 architectural step-1 hardware growth generates a) 3-level solution-2D-wBBBs, which can grow from 1D-base-wBBB #61, 1D-mid-wBBB #71 and 1D-top-wBBB #91 as shown in FIG. 3, into 2D-base-wBBB [Matrix of multi-layer components (#61, #73) and component #63], 2D-mid-wBBB #77 and 2D-top-wBBB #93 and b) 3-level knowledge-2D-wBBBs, which can grow from 1D-base-wBBB #63, 1D-mid-wBBB #77 and 1D-top-wBBB #93 as shown in FIG. 3, into 2D-base-wBBB [Polygon of multi-side components (#63, #83) and component #75], 2D-mid-wBBB #77 and 2D-top-wBBB #93; 2) the wG1.2 architectural step-2 hardware growth generates a) solution 2D-wPylon #190 comprising top-wBBB #93, mid-wBBB #77 and base-wBBB (Matrix of multi-layer components (#61, #73) and component #63) and b) knowledge 2D-wPylon #210, comprising top-wBBB #93, mid-wBBB #77 and base-wBBB (polygon of multi-side components (#63, #83) and component #75); 3) the wG1.2 architectural step-3 hardware growth generates 2D-wSubsystem that comprises solution 2D-wPylon #190 inter-coupled with knowledge 2D-wPylon #210 via WL2; 4) the wG1.2 architectural step-4 hardware growth generates 2D task-expert workgroup production service system that comprises top-level wBBB #51 or #93, mid-level wBBB #85, base-level Solution wPylon #190 and base-level knowledge wPylon #210.

Therefore, by completing four workgroup-architectural step-up (step-1/step-4) schemes enabled growth with 7 built-in workgroup-computing mechanisms, 2D task-Expert workgroup production service systems can evolve into existence in wG1.2, achieving real-time peer-to-peer negotiable workgroup-AI PS-service competency that is equal to the expert HI PS-service competency and meet the fourth strong-AI PS-service competency requirement.

In addition, each 2D task-expert system domain can accommodate an array of expert-TcPs, x*y number of 2D-solution-TeamProcessors (TaPs) and x*4 (sides) number of 2D-knowledge-TeamProcessors (TaPs) to accesses the local intelligent libraries for encapsulating 2D-complex production problem-domain with real-time concurrent Strong-2D AI-PS capabilities, based on architectural parameters' (x, y) expansion in positive counting numbers.

In summing up, the Strong-AI 2D task-expert workgroup production service systems are created based on four workgroup architectures and equipped with 7 “step-up” digital-computing advancements, including: 1) multi-thread processing computing, 2) parallel-accelerating processing computing, 3) OSI-7 data-network processing computing, 4) multi-application concurrent processing computing, 5) semantic-domain transaction-computing, 6) collaborative-domains automation computing and 7) peer-to-peer feedback-interactive service computing.

### 4.3 wG1.Stage-3 (wG1.3) Evolutionary Growth in Building Up Strong-AI 3D Task-Expert Workgroup Production Service Systems.

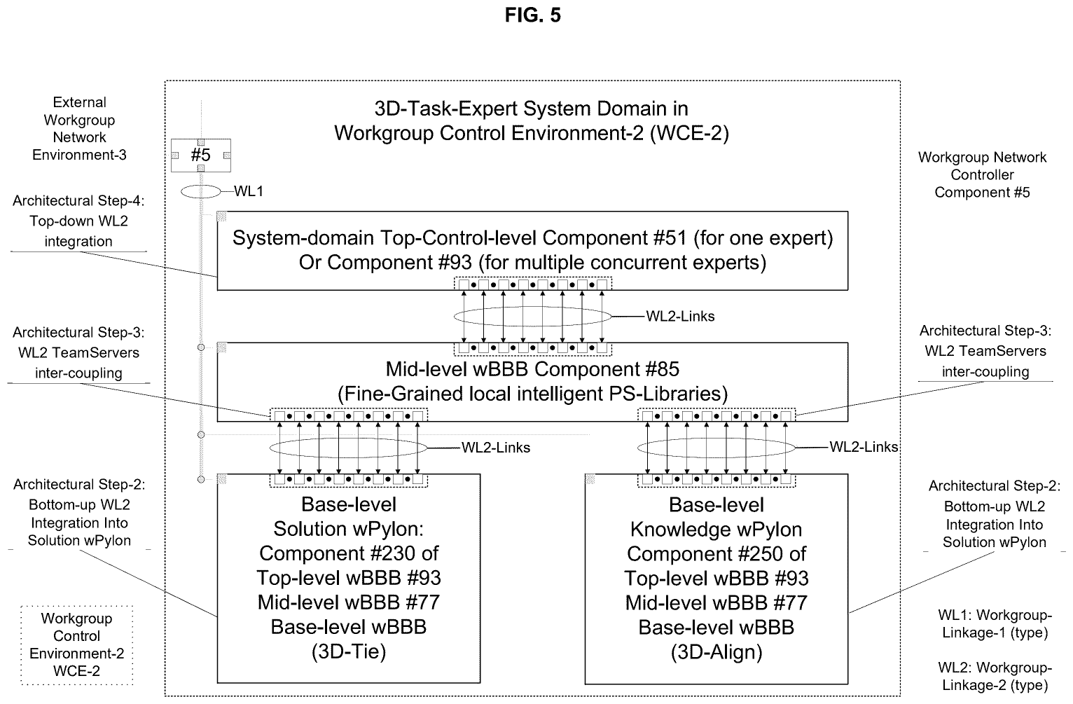

FIG. 5 is a block diagram depicting an exemplary embodiment of the current disclosure of a real-time concurrent feedback-control-based 3D-closed-loop multi-application-integrated Strong AI 3D task-expert workgroup production service system, equipping with seven computing advancements, according to at least one embodiment of the present invention. As shown in FIG. 5, there are four wG1.3 workgroup architectural step-up hardware growth from 2D task-expert workgroup production service system into 3D task-Expert workgroup production service systems in the third stage of the first workgroup evolutionary generation. They are 1) the wG1.3 architectural step-1 hardware growth generates a) 3-level solution-3D-wBBBs, which can grow from 2D-base-wBBB (Matrix), 2D-mid-wBBB #77 and 2D-top-wBBB #93 as shown in FIG. 4, into 3D-base-wBBB [Tie of multiple 2D-components #190] and component #63], 3D-mid-wBBB #77 and 3D-top-wBBB #93 and b) 3-level knowledge-3D-wBBBs, which can grow from 2D-base-wBBB (Polygon), 2D-mid-wBBB #77 and 2D-top-wBBB #93 as shown in FIG. 4, into 3D-base-wBBB [Align of multiple 2D-components #210], 3D-mid-wBBB #77 and 3D-top-wBBB #93; 2) the wG1.3 architectural step-2 hardware growth generates a) solution 3D-wPylon #230 comprising top-wBBB #93, mid-wBBB #77 and base-wBBB [Tie of multiple 2D-components #190] and b) knowledge 3D-wPylon #250, comprising top-wBBB #93, mid-wBBB #77 and base-wBBB [Align of multiple 2D-components #210]; 3) the wG1.3 architectural step-3 hardware growth generates 3D-wSubsystem that comprises solution 3D-wPylon #230 inter-coupled with knowledge 3D-wPylon #250 via WL2; 4) the wG1.3 architectural step-4 hardware growth generates 3D task-Expert workgroup production service system that comprises Top-level wBBB #51 or #93, mid-level wBBB #85, base-level Solution wPylon #230 and base-level knowledge wPylon #250.

Therefore, by completing the four workgroup-architectural step-up (step-1/step-4) schemes-enabled growth with 7 built-in workgroup-computing mechanisms, 3D task-expert workgroup production systems can evolve into existence in wG1.3, achieving real-time peer-to-peer negotiable workgroup-AI PS-service competency that is equal to the expert HI PS-service competency and meet the fourth strong-AI PS-service competency requirement.

In addition, each 3D task-expert system domain can accommodate an array of expert-TcPs, (x, y, z) number of solution-TeamProcessors (TaPs) and (x,y,z) number of knowledge-TeamProcessors (TaPs) to accesses the local intelligent libraries for encapsulating 3D-complex production problem-domain with real-time concurrent Strong-3D AI-PS capabilities based on architectural parameters' (x, y, z) expansion in positive counting numbers.

In summing up, the Strong-AI 3D task-expert workgroup production service systems are created based on 4 workgroup architectures and equipped with 7 “step-up” digital-computing advancements, including: 1) multi-thread processing computing, 2) parallel-accelerating processing computing, 3) OSI-7 data-network processing computing, 4) multi-application concurrent processing computing, 5) semantic-domain transaction-computing, 6) collaborative-domains automation computing and 7) peer-to-peer feedback-interactive service computing.

### 4.4 wG1.Stage-4 (wG1.4) Evolutionary Growth in Building Up Strong-AI Fractal Task-Expert Workgroup Production Service Systems.

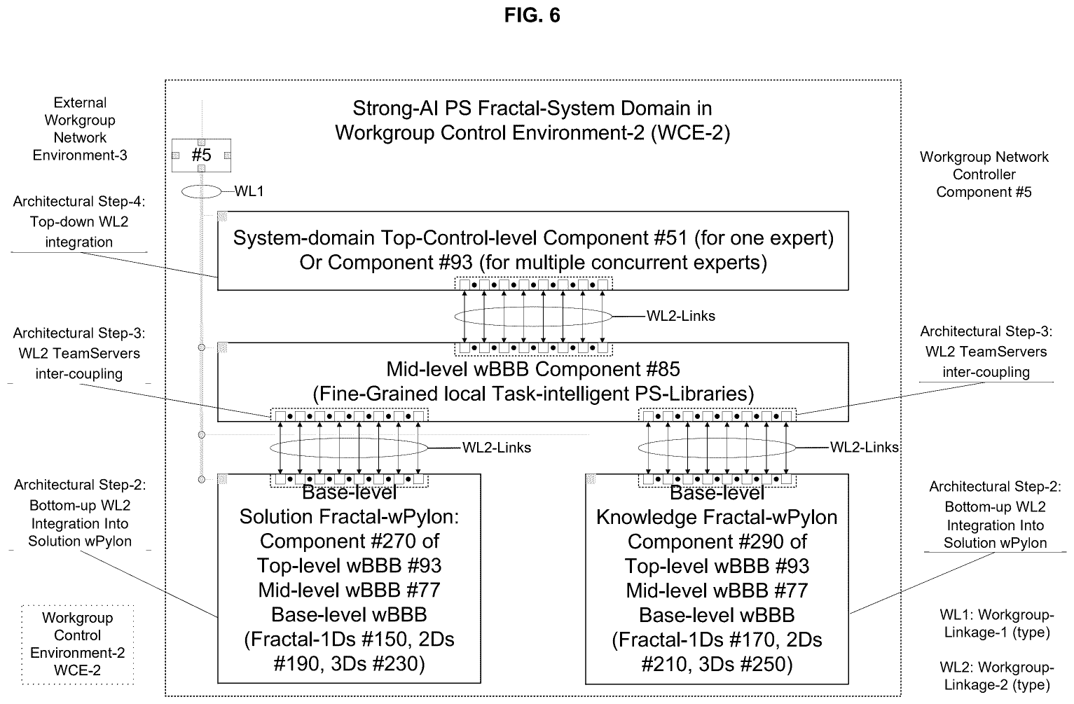

FIG. 6 is a block diagram depicting an exemplary embodiment of the current disclosure of a real-time concurrent feedback-control-based Multi-3D-Fractalfractal-closed-loop multi-application-integrated Strong-AI Fractal task-expert workgroup production service system, equipping with seven computing advancements, according to at least one embodiment of the present invention. As shown in FIG. 6, there are four workgroup architectural step-up schematic growth from 3D-concurrent workgroup expert system into multi-3D Fractal concurrent workgroup expert systems, in the fourth stage of the first workgroup evolutionary generation, (wG1.4). They are 1) the wG1.4 architectural step-1 hardware growth generates a) 3-level solution Fractal-wBBBs, which can grow from 3D-base-wBBB (Tie), 3D-mid-wBBB #77 and 3D-top-wBBB #93 as shown in FIG. 5, into Fractal-base-wBBB [Fractal of 1Ds #150, 2Ds #190, 3Ds #230], Fractal-mid-wBBB #77 and Fractal-top-wBBB #93 and b) 3-level knowledge Fractal-wBBBs, which can grow from 3D-base-wBBB (Align), 3D-mid-wBBB #77 and 3D-top-wBBB #93 as shown in FIG. 5, into Fractal-base-wBBB [Fractal of 1Ds #170, 2Ds #210, 3Ds #250], Fractal-mid-wBBB #77 and Fractal-top-wBBB #93; 2) the wG1.4 architectural step-2 hardware growth generates a) solution Fractal-wPylon #270 comprising top-wBBB #93, mid-wBBB #85 and base-wBBB [Fractal of array-1Ds #150, matrix-2Ds #190, tie-3Ds #230] and b) knowledge 3D-wPylon #290, comprising top-wBBB #93, mid-wBBB #85 and base-wBBB [Fractal of segment-1Ds #170, polygon-2Ds #210, align-3Ds #250]; 3) the wG1.4 architectural step-3 hardware growth generates Fractal-wSubsystem that comprises solution Fractal-wPylon #270 inter-coupled with knowledge Fractal-wPylon #290 via WL2; 4) the wG1.4 architectural step-4 hardware growth generates Fractal task-Expert workgroup production service system that comprises Top-level wBBB #51 or #93, mid-level wBBB #85, base-level Solution wPylon #270 and base-level knowledge wPylon #290.

Therefore, after carrying out four wG1.4 workgroup-architectural step-up (step-1/step-4) schemes with 7 built-in workgroup-computing mechanisms, Fractal task-expert workgroup production systems can evolve into existence in wG1.4, achieving real-time peer-to-peer negotiable workgroup-AI PS-service competency that is equal to the expert HI PS-service competency and meet the fourth strong-AI PS-service competency requirement.

In addition, each 3D-fractal task-expert system domain can accommodate an array of expert-TcPs, multiple m* (x*y*z)-number of 3D-solution-TeamProcessors (TaPs) and multiple n* (x*4*z) number of 3D-knowledge-TeamProcessors (TaPs) to accesses the local intelligent libraries for encapsulating multi-3D-complex production problem-domain with real-time concurrent Strong-Fractal AI-PS capabilities based on architectural parameters' (m, n, x, y, z) expansion in positive counting numbers.

In summing up, the Strong-AI Fractal task-expert workgroup production service systems are created based on four workgroup architectures and equipped with 7 step-up digital-computing advancements.

4.5 wG1.stage-5 (wG1.5) evolutionary growth in building up Strong-AI fail-safe Fractal task-Expert Workgroup Production Service Systems.

There are 2 additional workgroup architectures in addition to the above-mentioned 4 workgroup architectures. They are 1) the fifth workgroup fail-over architecture (including: workgroup architecture-5) via WL3-multi-link architectural devices (TeamPanels) and 2) the sixth workgroup fail-safe architecture (including: workgroup architecture-6) via WL4 multi-link architecture devices (Team-Switches), as illustrated in US Patent hardware patent.

Moreover, these two workgroup growth architectures will enable the following workgroup architectural step-5 scheme for building up fail-over task-expert workgroup service systems and workgroup architectural step-6 scheme for building up fail-safe task-expert workgroup service systems.

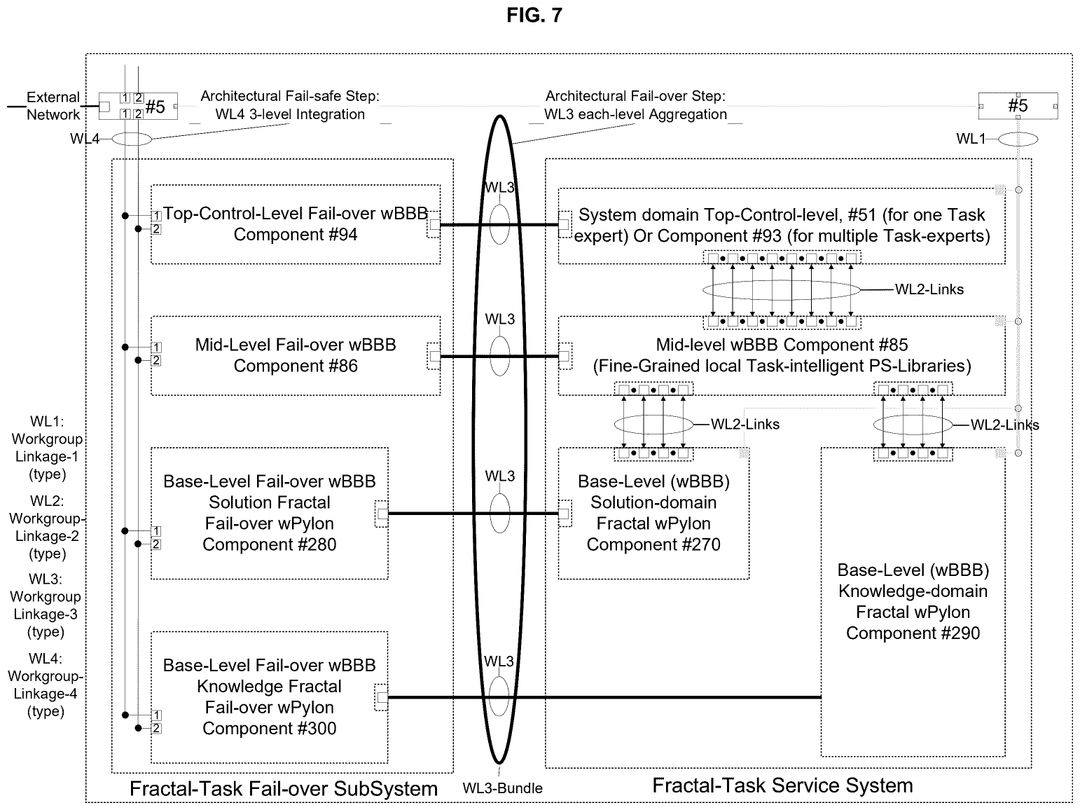

FIG. 7 is a block diagram depicting an exemplary embodiment of the current disclosure of a wG1.stage real-time “fail-safe” Strong-AI Fractal task-expert workgroup production service system, equipping with 9 computing advancements, according to at least one embodiment of the present invention. As shown in FIG. 7, there are the fifth and the six architectural step-up schemes that can build from multi-3D Fractal concurrent task-expert workgroup service systems into fail-safe-concurrent Fractal-expert workgroup production service systems, in the fifth stage of the first workgroup evolutionary generation, (wG1.5).

The workgroup architectural step-5 scheme builds up fail-over workgroup service Systems based on workgroup architecture-5 via three (3) hardware/software/mechanism implementations by using WL3-based TeamPanel devices, as shown in FIG. 7. For all the wBBBs in the system, WSA patent-method can be used to set up 3-level wBBB-managers, such as components #93&94, components #85&86, components #270&280 and component #290&300, for real-time hot-swap fail-over management, where failed TcPs can be temporarily replaced by TcPm, failed TaPs can be temporarily replaced TaPm and failed TmPs can be temporarily replaced by TmPm, so that failed TeamProcessors can be replaced with working TeamProcessors, enabling real-time hot swap for the replacements to plug in without shutting down the whole system. This new and better workgroup fail-over mechanism can be classified as the eighth workgroup-computing mechanism.

The workgroup architectural step-6 scheme builds up fail-safe workgroup service System, based on workgroup architecture-6 via three (3) hardware/software/mechanism implementations by using WL4-based Team-Control Switch (component #5) devices, as shown in FIG. 7. By linking up 3-level fail-over TeamManagers via WL4 with Team-Control Switch, the top-level paired-TeamManagers can control mid-level paired-TeamManagers and base-level paired-TeamManagers and manage to react. If any failed system process is detected, top-level TeamManagers will send commands to mid-level and base-level TeamManagers for fail-over processes, as well as if any faulty system process is detected, top-level TeamManagers can spawn a new process via other top-level paired-TcPs to redo the faulty process. This new and better workgroup fail-safe mechanism can be classified as the ninth workgroup-computing mechanism.

After carrying out workgroup-architectural step-5 and step-6 schemes with fail-over/fail-safe system-growth with built-in 8 and 9 workgroup-computing mechanisms, fail-safe Fractal task-expert workgroup production service systems can be evolved and grow into existence in wG1.5. They can engender a long-running workgroup fail-safe mechanism event for solving any fail-safe production service-oriented problem with real-time workgroup fail-safe result that can be controlled and stored into internal TeamServers by system TcPm1/TcPm2 wOSs, achieving real-time fail-safe peer-to-peer interactive workgroup-AI PS-service competency that is better than the expert HI-PS-service competency and meet with the fourth strong-AI-PS-service competency requirement.

In addition, fail-safe Fractal task-expert workgroup production service systems can accommodate an array of expert-TcPs, multiple m* (x+y*z)-number of fail-over 3D-solution-TeamProcessors (TaPs) and multiple n* (x*4*z) number of fail-over 3D-knowledge-TeamProcessors (TaPs) to accesses the fail-over local intelligent libraries for encapsulating multi-3D-complex production problem-domain with real-time fail-safe and concurrent Fractal strong/workgroup AI-PS capabilities, based on architectural parameters' (m, n, x, y, z) expansion in positive counting numbers.

Similarly, based on the same fail-over and fail-safe step-up schemes, a series of 1D, 2D, 3D fail-safe task-expert workgroup production service systems can be established, by setting up the respective fail-over subsystems that can be integrated with the 1D, 2D, 3D task-expert systems as illustrated in FIGS. 3 to 6.

In summing up, the fail-safe Strong-AI (1D, 2D, 3D, Fractal) task-expert workgroup production service systems are created based on 6 workgroup architectures and equipped with 9 “step-up” digital-computing advancements, including: 1) multi-thread processing computing, 2) parallel-accelerating processing computing, 3) OSI-7 data-network processing computing, 4) multi-application concurrent processing computing, 5) semantic-domain transaction-computing, 6) collaborative-domains automation computing and 7) peer-to-peer feedback-interactive service computing, 8) fail-over service computing and 9) fail-safe service computing.

### 4.6 Conclusion: Service-Oriented Production Domain's Complexity can be Covered By Multi-Stage Growable Task-Expert Workgroup Production Service-Systems.

It can also be concluded the production domain PS-complexity of 1D-base, 2D-base, 3D-base is equal to the group, ring and field algebraic complexity respectively, because the integer numbers of one (+or *) operator-based group complexity can be created by 1D-base-level structures, and rational numbers of two (+, *) operator-based ring complexity can be created by 2D-base-level structures, and real-numbers of two (+, * with 0 and 1 inverse identity) operator-based field complexity can be created by 3D-base-level structures with both forward-direction 2D-substructures and backward-direction 2D-substructures. In other words, all the real world real-time growing production-based complexity with fail-safe protections can all be accommodated by the wG1.5 Fractal task-expert workgroup production service systems, which can real-time expand starting from one to multiple 1D task-expert workgroup production service systems that can further real-time grow into multiple 2D task-expert workgroup production service systems and into multiple 3D task-expert workgroup production service systems.

5.0 the First Generation Task-Expert Workgroup Production Service Systems can Further Evolve into the Next 6 Workgroup Generations Due to Ten (10) Workgroup Architectures.

As described, the first 3-environmental workgroup task-expert systems can evolve after 5 stages of scalability in the first workgroup evolutionary generation (wG1.1, to wG1.5) into a series of 1D/2D/3D/Fractal task-expert workgroup production service systems that are equipped with real-time fail-safe workgroup AI-PS competencies that further expand upon the four 3-environmental (4) expert-HI PS competencies with additional fail-safe capabilities and meet all the four (4) strong-AI PS-service competency requirements.

Therefore, the first generation task-expert workgroup production service systems can be deemed as Strong-AI task-expert “workgroup production service systems, which are, for example, ideal for enhancing the current personal computing (PC) with a built-in expert, allowing PC users to take advantages of 4 Strong-AI PS-expertise software, conduct interactive semantic transactional services with constantly updated solutions based on the up-to-the-current best experienced knowledges, eliminate all the unnecessary syntax-data-centric chores and increase fine-grained productivity without worrying about hackable syntax-data security issues.

In addition, wG1.s (s=1, 5) Strong-AI-PS “task-expert” workgroup production service systems can further evolve into a larger Strong-AI-PS 3-environmental workgroup service systems to accommodate bigger service-oriented problem domains, by treating them as the base-level Basic Building Blocks (wBBBs) and by going through the workgroup-architectural step-1 to step-6 implementation schemes that are based on six (6) workgroup architectures as discussed earlier.

Moreover, by iteratively going through the workgroup-architectural step-1-to-step-6 schemes, a series of strong-AI-PS fail-safe workgroup service systems can be all evolved into existence to accommodate all the real-world service-oriented problem domains from the smallest production service domains to the largest individual service domains, over the next 6 workgroup evolutionary generations. The details on the next six (6) workgroup generation's evolutions are discussed as follows.

### 5.1 Generation-2.Stages Evolutions Based on Six (6) Workgroup Architectures, Creating wG2.s Fail-Safe Strong-AI Job-Expert Workgroup Assembly Service Systems in 3 Computing Environments.

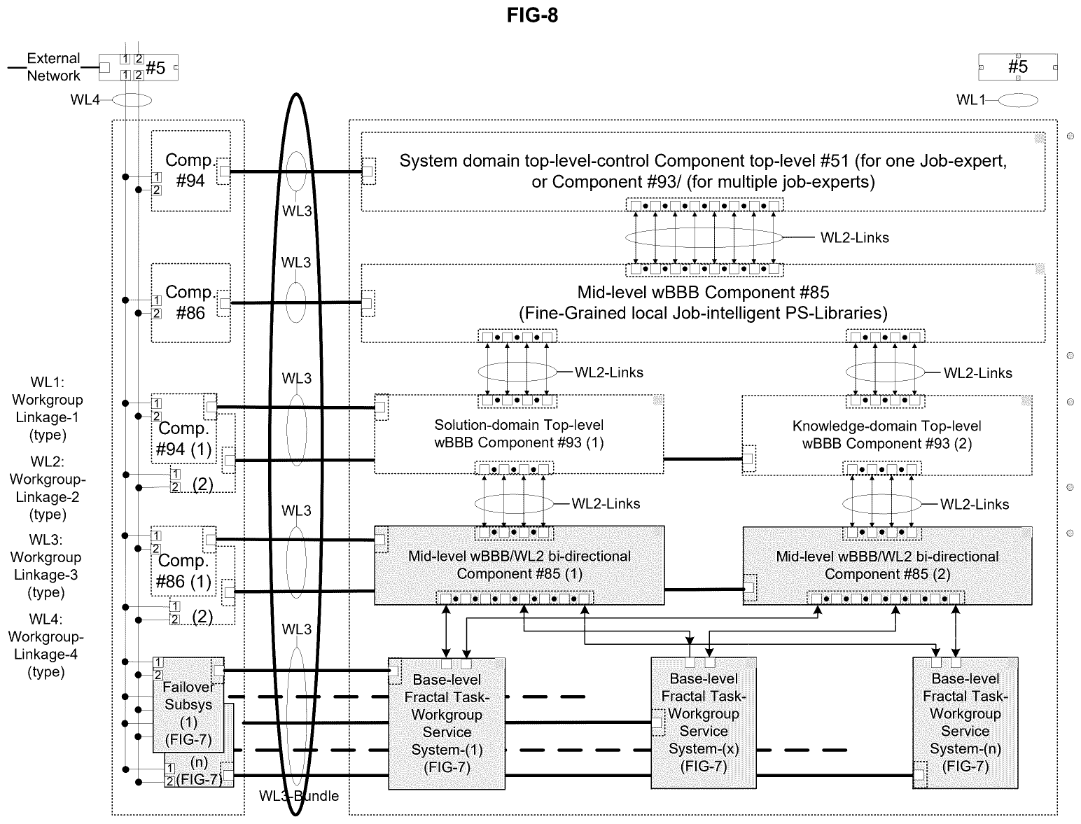

For accommodating multi-task workgroup production problem domains integrated workgroup assembly problem domain, there is a need for creating a series of bigger workgroup assembly systems. By aggregating multiple the first generation fail-safe task-expert workgroup-production service systems as the Basic-Building-Blocks (wBBBs) and by going through the above-mentioned workgroup architectural step-1 to step-6 schemes, the second workgroup generation (wG2) fail-safe 2-sided Job-expert strong-AI workgroup assembly service systems can be established, as illustrated in FIG. 8, achieving fail-safe peer-to-peer job-negotiable workgroup-AI PS-service competency with 10 “step-up” strong-AI digital-computing advancements, including: 1) multi-thread processing computing, 2) parallel-accelerating processing computing, 3) OSI-7 data-network processing computing, 4) multi-application concurrent processing computing, 5) semantic-domain transaction-computing, 6) collaborative-domains automation computing and 7) peer-to-peer feedback-interactive service computing, 8) fail-over service computing, 9) fail-safe service computing, and 10) evolutionary fail-safe service-systems evolutionary computing for evolving multi task-expert workgroup production services systems into Job-expert workgroup assembly service systems, where the tenth evolutionary advancement is based on the second Generation.stages (wG2.s) workgroup assembly service system evolutions.

FIG. 8 is a block diagram depicting an exemplary embodiment of the current disclosure of a fail-safe Strong-AI Job-expert workgroup assembly services system using 6 workgroup architectures and equipping 10 computing advancements with Strong-AI Job-expert of multiple Strong-AI task-experts based evolutionary generation-growth in the second workgroup generation (wG2), according to at least one embodiment of the present invention.

The related details of wG2.s job-assembly workgroup system's evolution with multiple stages of dimensional-(n-side) parameter growths in 3 workgroup assembly environments, including: 1) the first internal workgroup node processing and networking, 2) the growing second internal workgroup-assembly WL1-WL4 collaboration/control domain environment and 3) the third workgroup-assembly system external open environment, by using a plurality of wG1.s task-production workgroup systems via six (6) workgroup architectures, are illustrated from FIG. 25 to FIG. 32 in the U.S. Pat. No. 11,132,236.

### 5.2 Generation-3.Stages Evolutions Based on Six (6) Workgroup Architectures, Creating wG3.s Fail-Safe Strong-AI Case-Expert Workgroup Fabrication Service Systems in 3 Computing Environments.

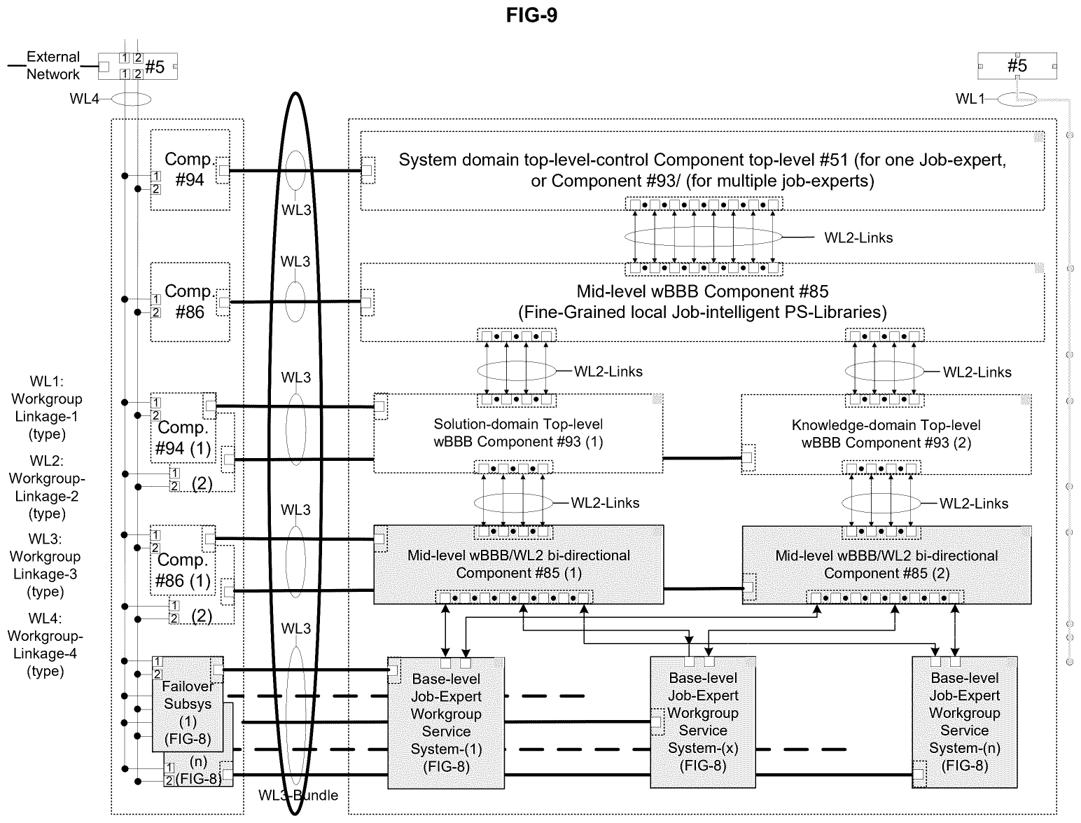

For accommodating multi-Job assembly problem domains integrated (managers) workgroup case-fabrication (manager) problem domains, there is a need for creating a series of bigger workgroup fabrication systems. By aggregating multiple the second generation fail-safe Job-expert workgroup-assembly systems as the Basic-Building-Blocks (BBBs) and by going through the above-mentioned workgroup-architectural step-1-to-step-6 schemes, the third workgroup generation (wG3) fail-safe 2-layer Case-expert strong-AI workgroup fabrication service systems can be established, as illustrated in FIG. 9, achieving fail-safe peer-to-peer case-negotiable workgroup-AI PS-service competency with 10 “step-up” strong-AI computing advancements, including: 1) multi-thread processing computing, 2) parallel-accelerating processing computing, 3) OSI-7 data-network processing computing, 4) multi-application concurrent processing computing, 5) semantic-domain transaction-computing, 6) collaborative-domains automation computing and 7) peer-to-peer feedback-interactive service computing, 8) fail-over service computing, 9) fail-safe service computing, and 10) fail-safe service-systems evolutionary computing for evolving multi Job-experts into a Case-expert, where the tenth evolutionary advancement is based on the third Generation.stages (wG3.s) workgroup fabrication service system evolutions.

FIG. 9 is a block diagram depicting an exemplary embodiment of the current disclosure of a fail-safe Strong-AI Case-expert workgroup fabrication services system using 6 workgroup architectures and equipping 10 computing advancements with more advanced Case-expert of multiple Job-experts based evolutionary generation-growth in the third workgroup generation (wG3), according to at least one embodiment of the present invention.

The related details of wG3.s case-fabrication workgroup system's evolution with multiple stages of dimensional-(n-layer and n-membrane) parameter growths in 3 workgroup fabrication environments, including: 1) the first internal workgroup node processing and networking, 2) the growing second internal workgroup-fabrication WL1-WL4 collaboration/control domain environment and 3) the third workgroup-fabrication system external open environment, by using a plurality of wG2.s job-assembly workgroup systems via six (6) workgroup architectures, are illustrated from FIG. 33 to FIG. 36 in the U.S. Pat. No. 11,132,236.

### 5.3 Generation-4.Stages Evolutions Based on Six (6) Workgroup Architectures, wG4.s Fail-Safe Strong-AI Contract-Expert/Agent Workgroup Transaction Service Systems in 3 Computing Environments.

For accommodating multi-case fabrication problem domains integrated workgroup contract-transaction problem domain with external text/audio/video 3-channels, there is a need for creating a series of bigger workgroup transaction systems. By aggregating 1) multiple wG1 fail-safe task-expert workgroup service systems, 2) multiple wG2 fail-safe Job-expert workgroup assembly service systems, 3) multiple wG3 fail-safe Case-expert workgroup fabrication service systems and 4) multiple wG3.s fail-safe case-fabrication workgroup systems as the Basic-Building-Blocks (wBBBs) respectively and by going through the above-mentioned workgroup-architectural step-1-to-step-6 schemes, the fourth workgroup generation (wG4) fail-safe multi-channel 4-type contract (internal)-expert/(external)-agent (including: type-1: Contract-expert/agent of task-experts, type-2: Contract-expert/agent of Job-experts, type-3: Contract-expert/agent of Case-experts and type-4: Contract-expert/agent of multi-case workgroup systems) based Strong-AI workgroup transaction service systems can be established, achieving fail-safe peer-to-peer contract-negotiable workgroup-AI PS-service competency with 10 “step-up”digital-computing advancements, including: 1) multi-thread processing computing, 2) parallel-accelerating processing computing, 3) OSI-7 data-network processing computing, 4) multi-application concurrent processing computing, 5) semantic-domain transaction-computing, 6) collaborative-domains automation computing and 7) peer-to-peer feedback-interactive service computing, 8) fail-over service computing, 9) fail-safe service computing, and 10) fail-safe service-systems evolutionary computing, where the tenth evolutionary computing advancement is based on the fourth Generation.stages (wG4.s) workgroup transaction service system evolutions.

The related details of wG4.s type-4 most-complicated Contract-expert/agent strong-AI workgroup transaction service system's evolution with multiple stages of dimensional-(2-channel and 3-channel) parameter growths in 3 workgroup transaction environments, including: 1) the first internal workgroup node processing and networking, 2) the growing second internal workgroup-transaction WL1-WL4 collaboration/control domain environment and 3) the third workgroup-transaction system external open environment, based on six workgroup architectures, are illustrated from FIG. 37 to FIG. 42 in the U.S. Pat. No. 11,132,236. As for type-1, type-2 and type-3 Contract-expert/agent strong-AI workgroup transaction service systems' evolutions, they are the same as the type-4 evolution, just by replacing the type-4 wBBBs with type-1, type-2, and type-3 wBBBs in the illustrated drawings respectively. The objectives of creating type-1 to type-3 workgroup transaction service systems are to generate smaller and less complicated Contract-expert/agent workgroup transaction service systems for accommodating real world smaller scales of workgroup transactions. All detailed descriptions of potential strong-AI type-4 workgroup transaction service systems will be disclosed in the upcoming patent application as an extension to the current patent application.

### 5.4 Generation-5.Stages Evolutions Based on Ten Workgroup Architectures, Creating wG5.s Fail-Safe Strong-AGI Smart-4 (Tier/Zone/Platform/Internet)-Agent Workgroup Business Service Systems in 3 Computing Environments.

For accommodating multi-contract transaction problem domains integrated business service domain, there is a need for creating a series of bigger workgroup business-service systems. By aggregating multiple the fourth generation fail-safe workgroup transaction service systems as the Basic-Building-Blocks (wBBBs) and by going through the above-mentioned workgroup-architectural step-1-to-step-6 implementation schemes, the fifth generation fail-safe enterprise service (internal)-expert/(external)-agent strong-AI workgroup business service systems can be established, achieving fail-safe peer-to-peer business-service-negotiable workgroup-(strong)-AI PS-service competency with 10 “step-up” strong-AI step-up digital-computing advancements, including: 1) multi-thread processing computing; 2) parallel-accelerating processing computing; 3) OSI-7 data-network processing computing; 4) multi-application concurrent processing computing; 5) semantic-domain transaction-computing, 6) collaborative-domains automation computing; and 7) peer-to-peer feedback-interactive service computing; 8) fail-over service computing; 9) fail-safe service computing, and 10) fail-safe service-systems workgroup evolutionary computing, which is based on the fifth Generation.stages (wG5.s) workgroup evolutions for evolving multi (wG4.s) 3-channel fail-safe workgroup transaction service systems into 3-channel enterprise-experts/agents fail-safe workgroup business service systems.

However, in order to cover even larger business service-oriented problem domains, from locale (master-agent)-service domain to multi-locale 2D-aggregated tier-service domain, to multi-tier integrated zone-service domain, to multi-zone 2D-aggregated external platform service domain and to multi-platform integrated Internet service domain, there are 4 additional workgroup architectures, including: 1) workgroup semantic tier-agent 1D/2D-aggregation architecture in building up workgroup business locale-service systems in 3 computing environments; 2) workgroup semantic zone-agent 3D-integration architecture in building up workgroup business zone-service systems; 3) workgroup semantic platform-agent 1D/2D-aggregation architecture in building up workgroup business platform-service systems in 3 computing environments; 4) workgroup semantic Internet-agent 3D-integration architecture in building up workgroup business Internet-service systems in 3 computing environments.

The related details of wG5.s strong-AI workgroup business service system's evolution and multiple stages of business-enterprise (departments, divisions, offices and the central) growths in 3 workgroup business computing environments, including: 1) the first internal workgroup node processing and networking, 2) the growing second internal workgroup-business service collaboration/control/virtual domain environment and 3) the third workgroup-business service system external open environment, based on ten workgroup architectures, are illustrated from FIG. 43 to FIG. 51 in the U.S. Pat. No. 11,132,236. All detailed descriptions of potential strong-AGI business-4 agent-based Smart-Enterprise systems will be disclosed in the upcoming patent application as an extension to the current patent application.

5.5 Generation-6.Stages Evolutions Based on Ten (10) Workgroup Architectures, Creating wG6.s Fail-Safe Strong-AGI Smart-4 (Tier/Zone/Platform/Internet)-Agent Workgroup Consumer Service Systems in 3 computing environments.

For accommodating consumer service problem domains, there is a need for creating a series of workgroup consumer-service systems. By aggregating multiple the fourth generation fail-safe Contract-expert/agent workgroup transaction systems as the Basic Building Blocks (wBBBs) that are embedded with the fifth generation business agent/subagent services and by going through the above-mentioned ten workgroup-architectural step-up (step-1 to step-10) schemes, the sixth workgroup generation (wG6) fail-safe apparatus (internal)-expert/(external)-agent strong-AI workgroup consumer service systems for homes, cars and robots can be established, achieving fail-safe peer-to-peer consumer-service-negotiable workgroup-(strong)-AI PS-service competency with 10 “step-up” strong-AI digital-computing advancements, including: 1) multi-thread processing computing, 2) parallel-accelerating processing computing, 3) OSI-7 data-network processing computing, 4) multi-application concurrent processing computing, 5) semantic-domain transaction-computing, 6) collaborative-domains automation computing and 7) peer-to-peer feedback-interactive service computing, 8) fail-over service computing, 9) fail-safe service computing, and 10) fail-safe service-systems workgroup evolutionary computing, which is based on the sixth Generation.stages (wG6.s) workgroup evolutions for evolving multi (wG4.s) 3-channel contract-transaction workgroup service systems into 3-channel apparatus-experts/agents workgroup consumer service systems.

The related details of wG6.s strong-AI workgroup consumer service systems' evolution for accommodating consumer's homes/cars/robots with multiple stages of consumer-apparatus (appliances, gears, gadgets and the widget) growths in 3 three workgroup consumer computing environments, including: 1) the first internal workgroup node processing and networking, 2) the growing second internal workgroup-consumer service collaboration/control/virtual domain environment and 3) the third workgroup-consumer service system external open environment, based on ten workgroup architectures, are illustrated from FIG. 52 to FIG. 57 in the U.S. Pat. No. 11,132,236. All detailed descriptions of potential strong-AGI consumer-4 agent-based Smart-Home, Smart-Car, and Smart-Robot systems will be disclosed in the upcoming patent application as an extension to the current patent application.

### 5.6 Generation-7.Stages Evolutions Based on Ten Workgroup Architectures, Creating wG7.s Fail-Safe Strong-AGI Smart-4 (Tier/Zone/Platform/Internet)-Agent Workgroup Individual Service Systems in 3 Computing Environments.

For accommodating individual-service problem domains, there is a need for creating a series of workgroup individual service-oriented systems. By aggregating multiple the first generation fail-safe task-expert workgroup production service systems as the Basic Building Blocks (wBBBs) that are embedded with the fifth generation business agent/subagent services as well as the sixth generation consumer agent/subagent services and by going through the above-mentioned ten workgroup-architectural step-up (step-1 to step-10) schemes, the seventh workgroup generation (wG7) fail-safe PDA (internal)-expert/(external)-agent strong-AI workgroup individual service systems can be established, achieving fail-safe peer-to-peer individual-service-negotiable workgroup-(strong)-AI PS-service competency with ten “step-up” strong-AI digital-computing advancements, including: 1) multi-thread processing computing, 2) parallel-accelerating processing computing, 3) OSI-7 data-network processing computing, 4) multi-application concurrent processing computing, 5) semantic-domain transaction-computing, 6) collaborative-domains automation computing and 7) peer-to-peer feedback-interactive service computing, 8) fail-over service computing, 9) fail-safe service computing, and 10) fail-safe service-systems workgroup evolutionary computing, which is based on the seventh Generation.stages (wG7.s) workgroup evolutions for evolving from multi (wG1.s) task-expert workgroup production service systems into 3-channel PDA service experts/agents workgroup individual service systems.

The related details of wG7.s strong-AI workgroup individual service system's evolution with multiple stages of individual-PDA (compact-appliances, compact-gears, compact-gadgets and the compact-widget) growths in 3 workgroup-individual computing environments, including: 1) the first internal workgroup node processing and networking, 2) the growing second internal workgroup-individual service collaboration/control/virtual domain environment and 3) the third workgroup-individual service system external open environment, based on ten (10) workgroup architectures, are illustrated from FIG. 58 to FIG. 64 in the U.S. Pat. No. 11,132,236. All detailed descriptions of potential strong-AGI individual-4 agent-based Smart-PDA systems will be disclosed in the upcoming patent application as an extension to the current patent application.

### 5.7 wCP Comprises Ten Workgroup Architectures

In conclusion, the workgroup-computing paradigm (wCP) comprises up to ten (10) workgroup architectures with architectural-linkage devices, i.e., 1) uni-workgroup-node processing architecture-1 via enhanced node-von Neumann with additional workgroup-processing devices, 2) uni-workgroup-node networking architecture-2 via enhanced node-networking 1D/2D-connections with new workgroup-node network-controllers, 3) multi-workgroup-node 3-level 1D/2D-aggregation architecture-3 with WL1 (Workgroup-Linkage-type-1)-Controllers, 4) multi-workgroup-node 3-level hierarchical 3D-integration architecture-4 with WL2-TeamServers, 5) multi-workgroup-node fail-over 1D/2D-aggregation architecture-5 with WL3-TeamPanels, 6) multi-workgroup-node fail-safe 3D-integration architecture-6 with WL4-Controllers, 7) multi-workgroup-node tier-agent 1D/2D-aggregation architecture-7 with WL5 semantic tier-agent controllers, 8) multi-workgroup-tier zone-agent 3D-integration architecture-8 with WL6 semantic zone-agent controllers, 9) multi-workgroup-zone platform-agent 1D/2D aggregation architecture-9 with WL7 semantic platform-agent controllers and 10) multi-workgroup-platform Internet-agent 3D integration architecture-10 with WL8 semantic Internet-cloud-agent-controllers.

### 5.8 Conclusion:

The present disclosed workgroup Computing Paradigm (wCP) comprises ten (10) workgroup architectures, which are eight hierarchy-centric workgroup architectures in addition to the current two workgroup-upgraded planar-only uni-node architectures. These ten (10) workgroup architectures equipped with architectural environmental-linked devices, derive the subsequently workgroup software 1D-connection/2D-aggregation/3D-integration domain theories/methods and develop the upcoming workgroup 3D-mechanism-integrated system disciplines that are capable of creating all the 7-generation Strong-AI workgroup service systems, including: 1) task-expert workgroup production service systems, 2) Job-expert workgroup assembly service systems, 3) Case-expert workgroup fabrication service systems and 4) Contract-expert workgroup transaction service systems in two (2) computing environments and 5) smart expert & agent workgroup business service systems, 6) smart expert & agent workgroup consumer service systems and 7) smart expert & agent workgroup individual service systems in three computing environments. Therefore, the workgroup-Computing Paradigm (wCP) is deemed Strong-AI competent, because it can generate 7-generation workgroup service systems that are all Strong-AI-PS capable.

Most importantly, these Strong-AI wCP generated 7-generation workgroup service systems can encapsulate all the real world service-oriented problem domains, from the smallest production service domains to the largest individual Internet-service domains, enabling real-time peer-to-peer “negotiable” fine-grained adaptive services that are rendered among all the involved strong-AI workgroup service systems' stakeholders/owners without anyone controlling each peer-to-peer servicing data. While the current Weak-AI node-Computing Paradigm (nCP) comprising two (2) uni-node architectures, can only establish a series of nodes-service-infrastructures with centralized databases to map and penetrate all the real world service oriented problem domains, enabling client-server pre-set fixated modelled coarse-grained captive services that are rendered from the weak-AI service providers to zombie-like clients with the total control of all the client-servicing data.

That is the reason why Strong-AI wCP equipped with eight (8) additional hierarchy-centric workgroup architectures with WL1-to-WL8 hardware architectural devices are so important, because they achieve 8 “step-up” software domain theories/methods and hierarchical-mechanisms integrated system disciplines, creating 3D/3-environment 7-generation Strong-AI workgroup service systems for providing peer-to-peer interactive/negotiable fine-grained adaptive/proactive Strong-AI PS-services in 1) real-time 3-environmental interactive semantic-domain-based non-hackable security-checking, 2) real-time current-best expert-experiences-enabled reliable content-exchanging and 3) real-time negotiable fine-grained-proactive contract-fulfilling, all of which can satisfy the deterministic Maslow-5 needs for all the Strong-AI smart-enterprise/smart-apparatus (home/car/robot)/smart-PDA users without security and privacy issues on the Internet.

While the current Weak-AI nCP equipped with only two (2) planar uni-node architectures (including: von Neumann and node-network) without any hierarchical-evolutionary mechanisms, can only compel practitioners to stay in the 2D/2-environmental cocoon with Weak-AI-PS node-computing systems for developing “fixated-model-PS” solutions that are impossible to encapsulate any of real world service-oriented problem domains and thereby providing client-server interface/captive coarse-grained fixated/reactive Weak-AI PS-services in 1) hackable 2-environmental syntax-interface-modelled security-checking, 2) unreliable Large-Language-Modelled (LLM) content-exchanging for deterministic problem solving and 3) pre-set client-server-modelled coarse-grained-reactive contract-fulfilling, all of which cannot satisfy the deterministic Maslow-5 needs for captive client users, who cannot even have any weak-AI-PS capabilities for themselves. Moreover, all the client services from the Weak-AI-PS servers/service-providers are laden with unsolvable security and captive privacy issues on the Internet.

### 6.0 The Summary:

For any future digital computing advancement, it will depend on more advanced computing architectures, because more advanced computing architectures that build on top of the current architectures and create new and better components and linked methods to support more sophisticated structural-dimension graph and structural-environment theories, dictate more advanced software theories and programming methods that upgrade/encapsulate the current software theories and programming methods. Moreover, both more advanced hardware and software combined implementations can engender more advanced mechanism-based system disciplines for building up bigger computing systems with better PS-capabilities. Therefore, sophisticated multi-node computing mechanisms via advanced multi-node computing hardware architectures with derived multi-node software methods are the basic foundations for building up bigger service systems with better Strong-AI PS capabilities, instead of simply just resorting to devising software algorithms under the limited uni-node architectures.

The present invention discloses Strong-AI workgroup-Computing-Paradigm (wCP) that comprises ten workgroup architectures, creating multi-node computing mechanisms that can enable seven (7) “step-up” Strong-AI multi-node workgroup-computing advancements, including: 1) multi-application concurrent-processing workgroup-computing, 2) semantic-domain dynamic-programming workgroup-computing, 3) collaborative-domains PS-automation workgroup-computing via common local PS-libraries, 4) peer-to-peer feedback-interactive service workgroup-computing, 5) fail-over service workgroup-computing, 6) fail-safe service workgroup-computing, 7) evolutionary generations/stages expert/agent service system workgroup-computing, in addition to the current two uni-node architectures that create uninode computing mechanisms, enabling three step-up uni-node computing advancements, including: 1) multi-thread processing node-computing, 2) parallel-accelerating processing (i.e., singular application internal-concurrent processing) node-computing and 3) client-server data-network processing nodes-computing.

Moreover, all these seven (7) “step-up” Strong-AI multi-node workgroup-computing advancements are what the current Weak-AI node-Computing-Paradigm (nCP) cannot achieve. It is because the current nCP lacks eight step-up (8) more advanced multi-node workgroup architectures that had been discovered one-by-one since earlier 2000, based on the fundamental conceptual thinking of extending the “step-up” sharable/common secondary buffer-memory/local-storage/conveyer-working area everywhere and the ensuing patented enhancements of upgrading the existing 2 uni-node architectures with additional direct-access sharable team/workgroup-servers and workgroup-server-array (WSA) architectural components and enabling real-time coupled-2D-expansion-aggregation-based and hierarchical 3D-feedback-control integration-based multi-node architectural methods for building up “7-generation Strong-AI-PS workgroup service systems on the Internet”, instead of still using networking node-Operating Systems (nOS) confined with private/non-sharable secondary storages with 1D-connection-based uni-node architectural methods for building up non-evolvable Weak-AI-PS nodes-service-infrastructures on the Internet.

Therefore, the current 2 uni-node-architecture based Weak-AI node-Computing-Paradigm (nCP) shift to 10-workgroup architecture-based Strong-AI workgroup-Computing-Paradigm (wCP) is inevitable from digital computing evolutionary point of view, which reveals the fact that node-computing is just in the early few stages of the first-generation workgroup-computing. This inevitable shift can be achieved simply by upgrading/encapsulating the current node-processors into TeamProcessors in 3D-semiconductor formats, which can further enable subsequent constructions of 1) wBBBs in module formats, 2) wPylons in add-in-card formats, 3) each workgroup service system of 7-generations in mother-board formats and 4) all connected workgroup business service systems in rack-mount formats.

What is claimed is:

1. A workgroup computing system comprising:
a three-level workgroup computing architecture comprising:
a base-level workgroup basic building block (wBBB);
a mid-level wBBB, wherein the mid-level wBBB is communicably coupled with the base-level wBBB;
a top-level wBBB operation program, wherein the top-level wBBB operation program is communicably coupled with the mid-level wBBB;
a top-level wBBB management program, wherein the top-level wBBB management program is communicably coupled with the mid-level wBBB;
the three-level workgroup computing architecture is based on a plurality of workgroup architectures, the plurality of workgroup architectures comprise a step-up scheme, wherein a first workgroup architecture of the plurality of workgroup architectures in the step-up scheme is a von-Neumann node-processing architecture configured to generate node-processors, comprising a plurality of digital computing advancements, wherein the first workgroup architecture is configured to perform concurrent workgroup AI problem solving processing.

2. The workgroup computing system of claim 1, wherein the three-level workgroup computing architecture is configured to perform the plurality of digital computing advancements, wherein the plurality of digital computing advancements comprises:
multi-thread processing computing;
parallel-accelerating processing computing;
OSI-7 data-network processing computing; and
multi-application concurrent processing computing.

3. The workgroup computing system of claim 1, wherein the plurality of workgroup architectures in the step-up scheme further comprises:
a second workgroup architecture configured to step-up from the first workgroup architecture, and wherein the second workgroup architecture is a node-networking architecture with workgroup node network-controllers;
a third workgroup architecture configured to step-up from the second workgroup architecture, and wherein the third workgroup architecture is a three-level TeamProcessors WL1 aggregation multi-workgroup-node with Workgroup Linkage-1 (WL1) Controllers; and
a fourth workgroup architecture configured to step-up from the third workgroup architecture, and wherein the fourth workgroup architecture is a three-level TeamProcessors hierarchical WL2 integration multi-workgroup-node with Workgroup Linkage-2 (WL2) Controllers.

4. The workgroup computing system of claim 3, wherein the second workgroup architecture is further comprising a plurality of workgroup pylons (wPylons) with a collaborative mechanism, based on the plurality of workgroup architectures, and wherein the second workgroup architecture is configured to perform semantic-domain transaction computing, via a problem solving transaction mechanism.

5. The workgroup computing system of claim 4, wherein the third workgroup architecture is further comprising workgroup problem solving (PS) subsystems with automated collaborative PS mechanisms with common local PS-libraries, based on the plurality of workgroup architectures, and wherein the third workgroup architecture is configured to perform collaborative-domains automation computing.

6. The workgroup computing system of claim 5, wherein the fourth workgroup architecture is further comprising a top-down control peer-to-peer service mechanism, based on the plurality of workgroup architectures, and wherein the fourth workgroup architecture is configured to perform peer-to-peer feedback-interactive service computing.

7. The workgroup computing system of claim 6, configured to evolve with a multi-stage structural growth mechanism in a first workgroup-production evolutionary generation of a plurality of evolutionary generations, due to multi-node dimensional parameters, wherein the multi-stage structural growth mechanism comprises:
a first stage as a real-time concurrent feedback-control-based 1D closed-loop multi-application-integrated Strong-AI 1D task-expert workgroup production service system;
a second stage as a real-time concurrent feedback-control-based 2D closed-loop multi-application-integrated Strong-AI 2D task-expert workgroup production service system;
a third stage as a real-time concurrent feedback-control-based 3D closed-loop multi-application-integrated Strong AI 3D task-expert workgroup production service system; and
a fourth stage as a real-time concurrent feedback-control-based fractal closed-loop multi-application-integrated Strong-AI Fractal task-expert workgroup production service system.

8. The workgroup computing system of claim 7, wherein:
the multi-stage structural growth mechanism further comprising:
a fail-over task-expert; and
a fail-safe task-expert workgroup production service system;
the plurality of workgroup architectures are further comprising:
a fifth workgroup architecture is a fail-over architecture via a WL3 multi-link architectural device;
a sixth workgroup architecture is a fail-safe architecture via a WL4 multi-link architecture devices;
the plurality of digital computing advancements are further comprising:
fail-over service computing; and
fail-safe service computing.

9. The workgroup computing system of claim 8, configured to evolve with the multi-stage structural growth mechanism in a second workgroup-production evolutionary generation of the plurality of evolutionary generations, wherein the second workgroup-production evolutionary generation is a fail-safe job-expert workgroup services systems, and wherein the plurality of digital computing advancements further comprises evolutionary service-systems workgroup computing for evolving multi-task-expert workgroup production services systems into a plurality of job-expert workgroup assembly service systems.

10. The workgroup computing system of claim 9, wherein the plurality of job-expert workgroup assembly service systems further comprises:
a first internal workgroup node processing and networking;
a growing second internal workgroup-assembly WL1-WL4 collaboration/control domain environment; and
a third workgroup-assembly system external open environment.

11. The workgroup computing system of claim 9, configured to evolve with the multi-stage structural growth mechanism in a third workgroup-production evolutionary generation of the plurality of evolutionary generations, wherein the third workgroup-production evolutionary generation is a fail-safe case-expert workgroup fabrication services systems, wherein the fail-safe case-expert workgroup fabrication services systems comprises a plurality of dimensional (n-layer and n-membrane) parameter growths in workgroup fabrication environments.

12. The workgroup computing system of claim 11, the workgroup fabrication environments comprise:
a first internal workgroup node processing and networking,
a growing second internal workgroup-fabrication WL1-WL4 collaboration/control domain environment; and
a third workgroup-fabrication system external open environment.

13. The workgroup computing system of claim 7, the plurality of evolutionary generations meet four strong AI-PS-processing competency requirements of the Turing Test, wherein the four strong AI-PS-processing competency requirements determine whether a computer system is configured to demonstrate intelligence that is equal to human intelligence in problem solving.

14. The workgroup computing system of claim 13, wherein the four strong AI-PS-processing competency requirements comprise:
i) real-time concurrent PS-processing;
ii) real-time semantic PS-transactions;
iii) real-time automated PS-collaborations; and
iv) real-time peer-to-peer interactive Fine-Grained-Proactive (FGP) problem solving.

15. The workgroup computing system of claim 11, configured to evolve with the multi-stage structural growth mechanism in a fourth workgroup-production evolutionary generation of the plurality of evolutionary generations, wherein the fourth workgroup-production evolutionary generation is a fail-safe Contract-expert workgroup transaction services systems, wherein the fail-safe Contract-expert workgroup transaction services systems comprises contract-expert of task-experts, job-experts, case-experts, and multi-case workgroup systems-based evolutionary generation-growth in the fourth workgroup-production evolutionary generation.

16. The workgroup computing system of claim 15, configured to evolve with the multi-stage structural growth mechanism in a fifth workgroup-production evolutionary generation of the plurality of evolutionary generations, wherein the fifth workgroup-production evolutionary generation is a fail-safe workgroup business services systems, based on the plurality of workgroup architectures in the step-up scheme, configured to equip the plurality of digital computing advancements with agents of contract-transaction experts-based evolutionary generation/multi-stage growth in the fifth workgroup-production evolutionary generation.

17. The workgroup computing system of claim 16, configured to evolve with the multi-stage structural growth mechanism in a sixth workgroup-production evolutionary generation of the plurality of evolutionary generations, wherein the sixth workgroup-production evolutionary generation is a fail-safe workgroup consumer services systems, based on the plurality of workgroup architectures in the step-up scheme, configured to equip the plurality of digital computing advancements with consumer agents of contract-transaction experts-based evolutionary generation/multi-stage growth in the sixth workgroup-production evolutionary generation.

18. The workgroup computing system of claim 17, configured to evolve with the multi-stage structural growth mechanism in a seventh workgroup-production evolutionary generation of the plurality of evolutionary generations, wherein the seventh workgroup-production evolutionary generation is a fail-safe workgroup individual services systems, based on the plurality of workgroup architectures in the step-up scheme, configured to equip the plurality of digital computing advancements with individual agents of contract-transaction experts-based evolutionary generation/multi-stage growth in the seventh workgroup-production evolutionary generation.
